(19) United States
(12) Patent Application Publication
(10) Pub. No.: US 2014/0029635 A1
(43) Pub. Date: Jan. 30, 2014

(54) LASER POWER CONTROL USING BIAS AND MODULATION CURRENT FEEDBACK

(71) Applicant: CALIX, INC., Petaluma, CA (US)

(72) Inventors: Mark R. Biegert, Rogers, MN (US); Peter O. Lee, Excelsior, MN (US); Mark T. Paulsen, Maple Grove, MN (US); Joel K. Lagerquist, St. Paul, MN (US)

(73) Assignee: CALIX, INC., Petaluma, CA (US)

(21) Appl. No.: 13/725,317

(22) Filed: Dec. 21, 2012

Related U.S. Application Data
(60) Provisional application No. 61/675,285, filed on Jul. 24, 2012.

(51) Int. Cl. H01S 3/02

(52) U.S. Cl. CPC H01S 3/02
USPC 372/38.04

(57) ABSTRACT

Techniques are described for maintaining the extinction ratio of an output optical signal over temperature and aging. In some examples, the techniques may determine the instantaneous slope efficiency of the laser outputting the optical signal, while the laser is outputting the optical signal. Based on the determined slope efficiency, the techniques may determine the needed drive current components (e.g., at least one of the bias current and the modulation current) that results in maintaining the extinction ratio to within a desired range.

This application claims the benefit of U.S. Provisional Application No. 61/675,285 filed Jul. 24, 2012, which is hereby incorporated by reference in its entirety.

### TECHNICAL FIELD

The present disclosure generally relates to controlling laser power.

### BACKGROUND

An optical network includes an optical line terminal (OLT) coupled to a central device and one or more optical network units (ONUs) with each ONU being coupled to one or more devices at a subscriber premises. The ONUs and the OLT each include an optical driver, such as a laser driver, to transmit information. For example, to transmit information upstream, an ONU includes a laser driver configured to drive current through a laser for purposes of upstream optical communication. The OLT similarly includes a laser driver to drive current through a laser for purposes of downstream optical communication.

The drive current includes a bias current and a modulation current. The bias current is used to bias the laser in its operating state. For example, the laser requires a threshold amount of current, referred to as I_{threshold}, to initiate lasing. The laser driver modulates the laser using the modulation current to cause the laser to output an optical high or an optical low (i.e., when the modulation current is on, the laser outputs an optical high, and when the modulation current is off, the laser outputs an optical low).

However, the I_{threshold} level is not constant, and is a function of temperature and laser aging. Therefore, the drive current may need to be adjusted to keep the laser in its operating state. Also, the optical power of the optical high and optical low, for a given modulation current, is a function of temperature and laser aging. Therefore, as the temperature changes and as the laser ages, the modulation current required to generate an optical high will change.

### SUMMARY

Techniques described in this disclosure are generally related to maintaining the average power output by a laser and an extinction ratio within a specified range across temperature and laser aging. The extinction ratio is the ratio of the optical power of optical high to the optical power of the optical low. For instance, in some examples, the techniques may maintain the average optical power and extinction ratio constant over temperature and laser aging by determining updated current values based at least in part on a measurement of the slope efficiency of the laser while the laser is generating optical signals to transmit optical data. Slope efficiency is defined as the change in instantaneous optical power relative to an instantaneous change in modulation current.

In one example, this disclosure describes a method that includes adjusting an average power of a laser from a first average power level to a second average power level while the laser is generating optical signals to transmit optical data, determining a change in a first current flowing through the laser due to the adjustment of the average power, determining a slope efficiency of the laser while the laser is transmitting the optical signals based at least on the adjustment of the average power and the determined change in the first current flowing through the laser, determining a level of a second current based at least in part on the determined estimate of the slope efficiency, and setting the second current equal to the determined level of the second current.

In one example, this disclosure describes a device. The device includes a laser and a control unit. The control unit is configured to adjust an average power of the laser from a first average power level to a second average power level while the laser is generating optical signals to transmit optical data, determine a change in a first current flowing through the laser due to the adjustment of the average power, determine a slope efficiency of the laser while the laser is transmitting the optical signals based at least on the adjustment of the average power and the determined change in the first current flowing through the laser, determine a level of a second current based at least in part on the determined estimate of the slope efficiency, and set the second current equal to the determined level of the second current.

In one example, this describes a control unit of a device. The control unit is configured to adjust an average power of a laser from a first average power level to a second average power level while the laser is generating optical signals to transmit optical data, determine a change in a first current flowing through the laser due to the adjustment of the average power, determine a slope efficiency of the laser while the laser is transmitting the optical signals based at least on the adjustment of the average power and the determined change in the first current flowing through the laser, determine a level of a second current based at least in part on the determined estimate of the slope efficiency, and set the second current equal to the determined level of the second current.

In one example, this disclosure describes a computer-readable storage medium having instructions stored thereon that when executed cause a control unit of a device to adjust an average power of a laser from a first average power level to a second average power level while the laser is generating optical signals to transmit optical data, determine a change in a first current flowing through the laser due to the adjustment of the average power, determine a slope efficiency of the laser while the laser is transmitting the optical signals based at least on the adjustment of the average power and the determined change in the first current flowing through the laser, determine a level of a second current based at least in part on the determined estimate of the slope efficiency, and set the second current equal to the determined level of the second current.

In one example, this disclosure describes a device comprising means for adjusting an average power of a laser from a first average power level to a second average power level while the laser is generating optical signals to transmit optical data, means for determining a change in a first current flowing through the laser due to the adjustment of the average power, means for determining a slope efficiency of the laser while the laser is transmitting the optical signals based at least on the adjustment of the average power and the determined change in the first current flowing through the laser, means for determining a level of a second current based at least in part on the determined estimate of the slope efficiency, and means for setting the second current equal to the determined level of the second current.

The details of one or more examples are set forth in the accompanying drawings and the description below. Other features, objects, and advantages of this disclosure will be apparent from the description and drawings, and from the claims.

### BRIEF DESCRIPTION OF DRAWINGS

FIG. 1 is a block diagram illustrating an example network system configured to perform aspects of the average optical power and extinction ratio control in accordance with one or more techniques described this disclosure.

FIG. 2 is a graph illustrating various concepts related to a laser system.

FIG. 3 is a graph illustrating optical output power versus drive current and ambient temperature for an example laser.

FIG. 4 is a block diagram illustrating an example ONU shown in FIG. 1 in more detail.

FIGS. 5A and 5B are graphs illustrating parameters of an example ONU where the parameters have shifted in accordance with one or more techniques of the present disclosure.

FIG. 6 is a flow diagram illustrating example operation in accordance with one or more techniques of the present disclosure.

FIG. 7 is a graph illustrating the calibration tolerance and the tracking error of a laser.

FIGS. 8A-8C are graphs illustrating the results of utilizing the techniques described in this disclosure to maintain the extinction ratio over temperature for different examples of lasers.

FIGS. 9A and 9B are graphs illustrating the spectral width and the dispersion power penalty of a typical laser as a function of extinction ratio.

FIG. 10 is a graph illustrating the effect of modulation depth on spectral width for an example laser.

### DETAILED DESCRIPTION

In general, this disclosure is directed to techniques to maintain, in an optical network, the average power output by a laser and an extinction ratio of the optical signal within a specified range across temperature and laser aging. An optical network, such as a passive optical network (PON), often delivers voice, video and/or other data among multiple network nodes. A PON is an example of a so-called “point-to-multipoint” network. A PON may conform to any of a variety of PON standards, such as broadband PON (BPON) (ITU G.983), gigabit-capable PON (GPON) (ITU G.984), or gigabit Ethernet PON (GEPON). The architecture of a point-to-multipoint network commonly includes a single central device that communicates with multiple network nodes. In the example of a PON, the central device is often referred to as an optical line terminal (OLT), and the network nodes are often referred to as optical network units (ONUs) or optical network terminals (ONTs). The OLT delivers data to multiple ONUs using a common optical fiber link. Passive optical splitters and combiners enable multiple ONUs to share the common optical fiber link. The optical line terminal (OLT) transmits information downstream to the ONUs, and receives information transmitted upstream from the ONUs. Each ONU terminates the optical fiber link for a residential or business subscriber, and is sometimes referred to as a subscriber or customer premises node.

The optical fibers, splitters, combiners, and other components positioned between the OLT and the ONUs are often collectively known as the optical distribution network (ODN). In a PON, an optical splitter enables downstream communication by demultiplexing optical signals from the OLT and forwarding each demultiplexed optical signal to the appropriate ONU. Similarly, an optical combiner enables upstream communication by multiplexing optical signals from multiple ONUs and forwarding the multiplexed optical signal to the OLT. The optical splitter and combiner are normally integrated to form a single optical device in the ODN. An optical splitter/combiner may be connected to the OLT via a single optical fiber, and to each ONU by a single, separate optical fiber.

An optical network, such as a PON, relies on “fiber-optic communication” to connect the OLT and ONUs through the ODN. Fiber optic communication is largely based on transmission of information over optical fibers. Optical fibers provide several advantages over other types of communication media, such as insulated metal wires. For example, optical fibers permit signals to travel longer distances with less or no loss of quality. In other words, optical fibers offer greater bandwidth over longer physical distances. As a result, networks using fiber optic communications have gained popularity in the communications industry.

In certain circumstances, it may be desirable for an ONU to be installed outdoors (e.g., on the side of a building). Outdoor installation may provide several benefits, such as allowing for a simplified installation process and/or easier access to the ONU. However, when installed outdoors, particularly in certain climates, ONUs may be subject to larger variations in operating temperature when compared to indoor installations. Such variations in temperature may affect the operation of the laser of the ONU, such as causing the laser output signal power to vary excessively. Another factor that may affect the operation of the laser is aging. The techniques described in this disclosure may compensate for the effects of changes in temperature and laser aging to maintain the laser output power and to maintain the ratio between the power of an optical high and the power of an optical low (i.e., the extinction ratio).

In some examples, maintaining the laser output power and maintaining the extinction ratio over a wide temperature range is complicated by the large variations in the slope efficiency and threshold current of each laser to keep the laser in an operating state. There are also substantial unit-to-unit variations between the lasers, even within the same manufacturing lot. In other words, the changes in the slope efficiency and threshold current experienced by one laser as a function of temperature and age may not be the same as the changes in the slope efficiency and threshold current experienced by another laser as a function of temperature and age, including lasers within the same manufacturing lot of lasers. Uncompensated or improperly compensated parameter variation distorts the signal quality of the laser transmission and leads to communication transport bit errors.

The slope efficiency of a laser is a ratio of the change in laser output power for a given change in drive current (i.e., where the drive current is above the threshold current needed for the laser to operate) flowing through the laser. For example, on a laser that is DC-coupled to the laser driver, the slope efficiency indicates the change in the optical power that a laser will output for a given change in modulation current amplitude of the modulation current flowing through the laser, provided that a fixed amount of bias current at or above threshold current for lasing is also flowing through the laser. The slope efficiency of the laser may be a function of temperature and laser aging (e.g., the slope efficiency is different at different temperatures and different based on the length of time the laser is in operation).

The threshold current is the amount of current needed to keep the laser in the lasing state. If the total current flowing through the laser is less than the threshold current, the laser is essentially off (i.e., not producing or producing very little optical power). The threshold current is also a function of temperature and laser aging. In general, during operation (e.g., when the laser is transmitting optical signals), if the instantaneous current flowing through the laser falls below the threshold current, and then rises above the threshold current, the amount of time it takes the laser to transition from the off state to the on state may be unknown and unpredictable. Accordingly, it is desirable to maintain the laser in its lasing state throughout the laser transmitting operation (e.g., the laser should remain in the lasing state whenever the laser is transmitting an optical signal).

Typically, digital systems focus on controlling average power and extinction ratio, variables which are functions of the slope efficiency of the laser and the threshold current of the laser. In some examples, a laser driver drives the laser and includes a feedback loop that allows the laser driver to maintain a constant average laser output power. However, while laser drivers may function well in maintaining the average power output by the laser over temperature and laser aging, the laser drivers perform poorly in maintaining the extinction ratio over temperature and laser aging. The techniques described in the disclosure describe an approach to address the deficiencies in the ability of the laser driver to maintain the extinction ratio over temperature and laser aging.

For example, the ONU and the OLT may each include a control unit. In accordance with the techniques described in the disclosure, the control unit may determine the instantaneous slope efficiency of the laser, while the laser is operating (e.g., while the laser is generating optical signals to transmit optical data). Based on the determined slope efficiency, the control unit may adjust the amount of current that flows through the laser to maintain the extinction ratio to the desired level. For instance, the control unit may cause the laser driver to adjust the amount of current that flows through the laser to maintain the extinction ratio to the desired level.

As described in more detail, the control unit may control the “0” level (i.e., digital low) of the optical signal, and the laser driver may control the average power. Controlling the average power and the “0” level may be considered equivalent to controlling average optical power and extinction ratio.

In some examples, the control unit may be hardwired to implement the example techniques described in this disclosure. For example, the control unit is designed with discrete components and logic circuitry to implement the example techniques. Alternatively, the control unit may execute software (e.g., firmware) such that when the control unit executes the software, the control unit implements the example techniques described in this disclosure. The techniques directed to the control unit executing software may be beneficial because legacy control units can be configured to implement the techniques described in this disclosure, rather than removing the legacy control units and replacing them with hardwired control units that implement the example techniques described in this disclosure.

For purposes of illustration, the techniques described in this disclosure are described with examples where the control unit executes the software that causes the control unit to implement the example techniques described in this disclosure for maintaining the extinction ratio of the optical signal. Also, the laser driver may be a hardware component that is designed to cause current to flow through the laser and designed to maintain the average power output by the laser. In this way, the described techniques may be considered as an approach that uses a combination of both hardware (e.g., the laser driver) and software (e.g., the software executing on the control unit) to compensate for the parameter variations by controlling the average power level and the “0” level. However, aspects of this disclosure are not so limited, and in other examples, the control unit may be hardwired to implement the techniques described in this disclosure for maintaining the extinction ratio.

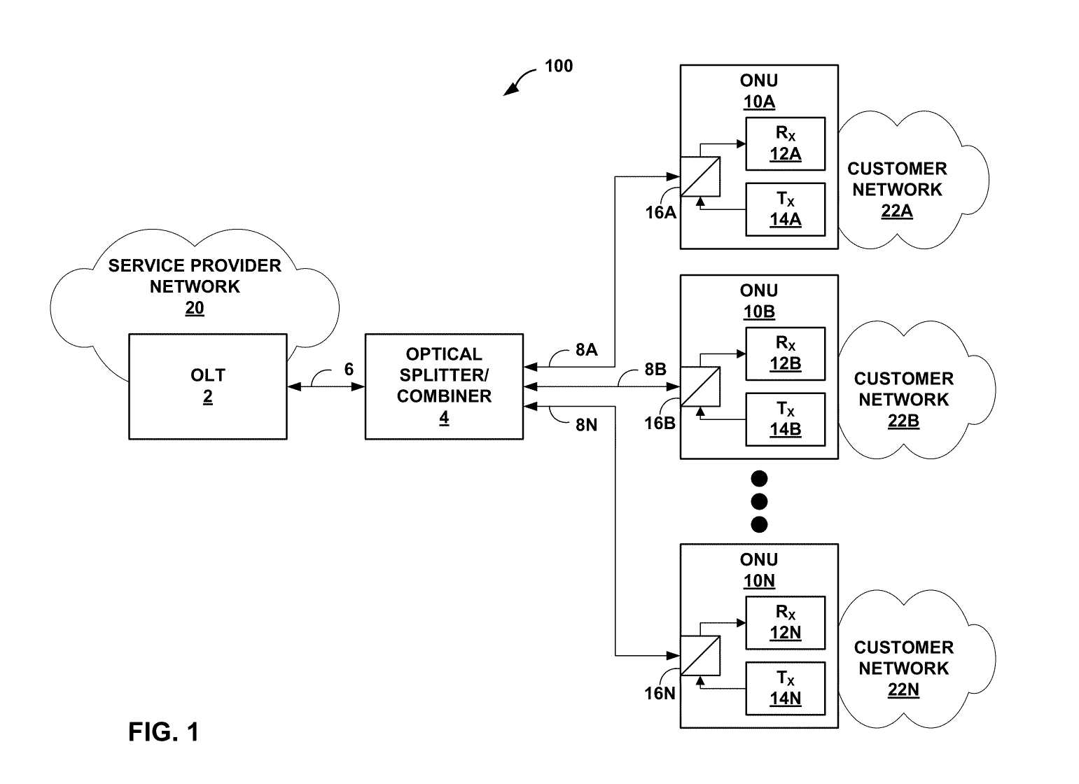

FIG. 1 is a block diagram illustrating an example network system 100 configured to perform aspects of the average optical power and extinction ratio control in accordance with one or more techniques described this disclosure. Network system 100 may conform to any of a variety of optical network standards such as broadband PON (BPON) (ITU G.983), gigabit capable PON (GPON) (ITU G.984), XGPON or 10G-PON (ITU 987), gigabit Ethernet PON (GEPON) (IEEE 802.3), active optical network (AON) (IEEE 802.3ah), and the like. For purposes of illustration only, network system 100 is described to represent a system that conforms to the GPON standard. While described with respect to a particular type of system (i.e., one that conforms to the GPON standard), the techniques may be implemented by other network systems that utilize an optical source (e.g., a laser) to transmit information, including non-PON standards.

In the example of FIG. 1, network system 100 includes service provider network 20 and customer networks 22A-22N (“customer networks 22”). Service provider network 20 represents a network that is commonly owned and operated by a service provider to provide one or more services to customer networks 22. Service provider network 20 may provide a number of different services to customer networks 22, including a voice service (often in the form of voice over Internet protocol or VoIP), a data service (which may be referred to as an Internet service or data plan) and a video service (which may be referred to as Internet protocol television or IPTV). Service provider network 20 is often a layer-three packet switched network that implements the third layer of the Open System Interconnection (OSI) reference model, where reference to layers in this disclosure may refer to layers of this OSI reference model.

Customer networks 22 may represent any network that is owned and operated by a customer of the service provider. Customer networks 22 may each include customer premise equipment (CPE), which is not shown in the example of FIG. 1 for ease of illustration purposes. CPE represents any device that may consume one or more of the services to which the corresponding customer subscribes. Examples of CPE may include television set-top boxes, telephones, tablet computers, laptop computers, workstations, desktop computers, netbooks, mobile phones (including so-called “smart phones”), video gaming devices, Internet-ready televisions, Internet-ready disc players, portable gaming devices, personal digital assistant (PDA) devices, routers, hubs, gateways, printers or any other device capable of receiving or otherwise interfacing with the services provided via service provider network 20.

Customer networks 22 are increasingly demanding more bandwidth within service provider network 20 to increasingly receive more and more services via the Internet rather than via separate communication systems (such as a cable coaxial network to receive television broadcasts or a plain old telephone system to receive voice calls). Moreover, service providers may increasingly prefer to maintain only a single data network for administrative and cost reasons, leading to a network architecture where all services are converging on the packet switched network for delivery to customer networks 22. While cable networks and the plain old telephone system (POTS) may support delivery of data services in conjunction with either video or voice, these networks do not commonly provide sufficient bandwidth to support all three, especially as delivery of video data is increasingly requiring ever growing amounts of bandwidth (considering that higher-resolution video is currently in high demand by many customers and requires significantly more bandwidth to deliver due to the higher resolution).

To meet both current demand and expected customer demand going forward, many service providers are forgoing previous cable networks or POTS to provide optical networks for the “last mile,” meaning the last mile to the customer. Optical networks provide large amounts of bandwidth to the customer. Network system 100 may represent one example of an optical network. Network system 100 may comprise a passive optical network (PON) or an active optical network (such as those referred to as an active Ethernet (AE) optical network). Regardless, network system 100 may conform to one of the standards referenced above, a proprietary standard, or may not conform to any particular standard.

Network system 100 includes an optical line terminal 2 (“OLT 2”) and optical network units 10A-10N (collectively referred to as “ONUs 10”). OLT 2 terminates the line coupling customer networks 22 to service provider network 20, while ONUs 10 each provide one or more interfaces between customer networks 22 and service provider network 20. OLT 2 generally represents any optical device that aggregates traffic from ONUs 10 for delivery upstream via service provider network 20 to the Internet or other destination. OLT 2 may transmit traffic from the Internet or other source to ONUs 10. As used in this disclosure, OLT 2 receiving information from ONUs 10 (e.g., ONUs 10 transmitting information) may be considered as information traveling in the upstream direction. OLT 2 transmitting information to ONUs 10 (e.g., ONUs 10 receiving information) may be considered as information traveling in the downstream direction.

In the example of FIG. 1, ONU 10A includes receiver (Rx) 12A, transmitter (Tₓ) 14A, and optical coupler 16A. ONUs 10B-10N may include similar components. For purposes of illustration, the techniques are described with respect to ONU 10A with the understanding that the other ONUs may function in a substantially similar manner.

Furthermore, OLT 2 may similarly include a receiver, transmitter, and optical coupler. OLT 2 may also implement the techniques described in this disclosure. However, for purposes of illustration the techniques for average power and extinction ratio control are described with respect to ONUs 10 with the understanding that OLT 2 may similarly implement the techniques for average power and extinction ratio control.

As shown in FIG. 1, optical coupler 16A may optically couple receiver 12A and transmitter 14A to optical fiber link 8A. In some examples, transmitter 14A receives data from customer network 22A and transmits the data in the form of an “optical signal” into fiber link 8A via optical coupler 16A. In some examples, receiver 12A receives data in the form of an optical signal from fiber link 8A via optical coupler 16A and transmits the data to customer network 22A. Additionally, while described as separate components, any or all of the components of ONU 10 may be implemented in a single component or any combination of components.

In the example of FIG. 1, OLT 2 is coupled to optical splitter/combiner 4 using optical fiber link 6. As shown in FIG. 1, optical splitter/combiner 4 may further be coupled to one or more ONUs 10 using optical fiber links 8A-8N (collectively referred to as “optical fiber links 8”). In some examples, optical splitter/combiner 4 receives data from OLT 2 in the form of an optical signal and distributes the optical signal to each of ONUs 10. More specifically, optical splitter/combiner 4 “splits” this optical signal to generate multiple copies of the received optical signal, transmitting a copy to each of ONUs 10. In these and other examples, optical splitter/combiner 4 may split an optical signal by first identifying a set of wavelengths included in the optical signal, and then generating multiple optical signals, each including a different subset of the set of wavelengths.

For purposes of illustration only, and in accordance with the GPON standard, optical splitter/combiner 4 is presumed to be a so-called “passive optical splitter.” For example, optical splitter/combiner 4 splits an optical signal received from OLT 2 by generating multiple copies (or “optical sub-signals”) of the signal and distributes the optical sub-signals to ONUs 10 using optical fiber lines 8 in the example of GPON without actively switching the sub-signals to the appropriate ones of ONUs 10 or requiring powered components. As illustrated in FIG. 1, optical splitter/combiner 4 may receive optical signals from ONUs 10, multiplex the received optical signals into a combined optical signal, and transmit the combined optical signal to OLT 2.

Each of ONUs 10 couples to respective customer networks 22. For example, ONU 10A may receive information from a CPE of customer network 22A, and may transmit the received information upstream to OLT 2. However, there may be connectivity issues in ONU 10A and OLT 2.

One way in which OLT 2 and ONUs 10 lose connectivity (or connection quality) is related to variations in the performance of transmitters 14. Though the potential issues described herein may apply to any one or more of transmitters 14, these potential issues are described with respect to transmitter 14A, for ease of discussion. In the example of FIG. 1, variations in the performance of transmitter 14A may be caused by various factors, such as temperature variations, effects of aging, manufacturing variations, etc. Variations in the performance of transmitter 14A may cause signal degradation (such as diminished signal strength) of communications relayed over optical fiber link 8A. In other words, communications between ONU 10A and OLT 2 may be negatively affected by variations in the performance of transmitter 14A.

For instance, in some examples, ONU 10A may reside external to the customer premises, and may be exposed to wide variations in temperature, as compared to if ONU 10A resided within the customer premises. Transmitter 14A may include a laser that ONU 10A uses to transmit upstream optical signals. The performance of the laser may be a function of temperature, and the wide temperature ranges that ONU 10A may experience may cause wide variations in the performance of the laser.

It should be noted that even in examples where ONU 10A resides within the customer premises there may be sufficient temperature variation that causes changes in the performance of the laser. The techniques described in this disclosure are applicable to examples where ONU 10A resides external to the customer premises, as well as examples where ONU 10A resides within the customer premises.

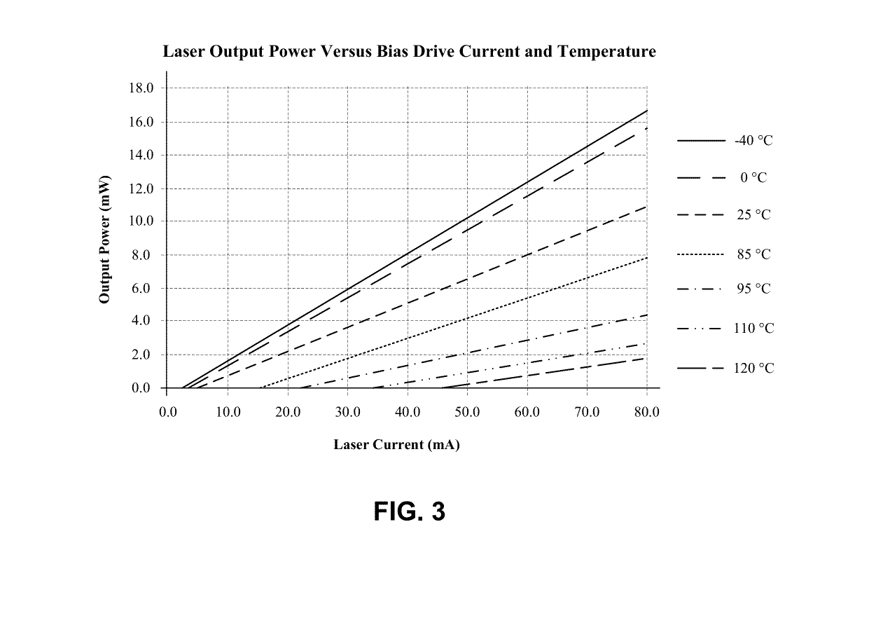

The changes in temperature may have the effect of changing the threshold current and slope efficiency of the laser of transmitter 14A. As described above, the threshold current of the laser may determine the amount of current that needs to flow through the laser to keep the laser in its lasing (e.g., operation) state. The slope efficiency may be ratio that indicates the change in optical power output by the laser for a given change in modulation current. As described in more detail below, FIG. 3 illustrates examples of the threshold current and slope efficiency as a function of temperature. Moreover, laser aging may also affect the threshold current and slope efficiency of the laser.

The threshold current and the slope efficiency may determine the amount of current that needs to flow through the laser of transmitter 14A for transmitting an optical signal. For example, the optical signal transmitted by transmitter 14A may be digital data comprising digital ones and digital zeros, where the optical power of the digital one (e.g., the amount of power the laser needs to output a digital one) is greater than the optical power of the digital zero (e.g., the amount of power the laser needs to output a digital zero). Because it may be desirable to keep the laser in its lasing state whenever the laser is transmitting the optical signal, the laser drive current (e.g., current flowing through the laser) for a digital zero should be greater than or equal to the threshold current.

The slope efficiency may define the difference in current levels between digital ones and digital zeros. For example, when transmitter 14A causes a current at a first current level to flow through the laser, the laser may output optical power at a first level, and when transmitter 14A causes a current at a second current level to flow through the laser, the laser may output optical power at a second level. If the optical power at the first level is considered as the optical power needed for transmitting a digital one, and the optical power at the second level is considered as the optical power needed for transmitting a digital zero, then the current at the first current level may be considered as the amount of current that needs to flow through the laser for the laser to output a digital one, and the second current level may be considered as the amount of current that needs to flow through the laser for the laser to output a digital zero.

As described above, the slope efficiency (SE) of the laser may be defined as the slope of the laser's optical output power versus the laser drive current level. Accordingly, if P1 designates the optical power for the digital one, and if P0 designates the optical power for the digital zero, then P1-P0 divided by the slope efficiency of the laser indicates the modulation current level (e.g., the difference between the first current level and the second current level). The separation between P1 and P0 may be referred to as the Optical Modulation Amplitude (OMA) and is used as a specified parameter some optical communication systems.

In optical communication systems, such as network system 100, ONU 10A may be configured to maintain the average power output by the laser of transmitter 14A and the extinction ratio of the optical signal output by the laser of transmitter 14A. Extinction ratio is a ratio between the optical power for a digital one and the optical power for a digital zero, and is generally defined as ER=P1/P0. The average power output by the laser (P_{avg}) is (P1+P0)/2 for a bit stream with equal numbers of digital ones and digital zeros, which is the usual case. The relationships between extinction ratio (ER), P_{avg}, P1, and P0 may be as follows:

ER=P1/P0;

P_{avg}=(P1+P0)/2

2*P_{avg}=P0+P1=P0+ER*P0=(ER+1)*P0

P0=2*P_{avg}/(ER+1)

P1=ER*P0=2*P_{avg}*ER/(ER+1)

ΔP=P1−P0=2*P_{avg}*ER/(ER+1)−2*P_{avg}/(ER+1)=2*P_{avg}*(ER−1)/(ER+1)

In general, it may be desirable to maintain the average power output by the laser and the extinction ratio within a desirable range. For example, the GPON standard may require the ER to stay above 8.2 dB, and may require the average power to be between 0.5 dBm and 5 dBm. However, the techniques described in this disclosure are not limited to these ranges for the extinction ratio and the average power.

As described above, the instantaneous level of the current needed for the laser to output P1 and the instantaneous level of the current needed for the laser to output P0 may be a function of the slope efficiency of the laser. Accordingly, if the slope efficiency of the laser changes, ONU 10A may need to cause transmitter 14A to adjust the amount of current that flows through the laser to maintain the extinction ratio and the average power within the desirable range.

For instance, if the amount of current that flows through the laser for transmitting digital ones and digital zeros is kept constant, and the slope efficiency increases, then the extinction ratio may increase to greater than 15 dB. In these cases, the laser output for the digital one may include ringing, since the current flowing through the laser will pass below and above the lasing threshold (i.e., the threshold current). Conversely, if the slope efficiency decreases, and the amount of current that flows through the laser for transmitting digital ones and digital zeros is kept constant, then the extinction ratio may decrease to less than 8.2 dB. This may result in the optical power of the digital ones and digital zeros to be too close, resulting in bit errors because OLT 2 may not be able to differentiate between the digital ones and digital zeros.

To ensure that average power and the extinction ratio are maintained within the desirable range, the ONU 10A may adjust the amount of current that flows through the laser such that the average power and the extinction ratio are within acceptable levels. Furthermore, ONU 10A may adjust the amount of current that flows through the laser to ensure that the laser remains in its lasing state during operation (e.g., the current flowing through the laser is greater than or equal to the threshold current of the laser during operation). For example, the slope efficiency and the threshold current may change based on temperature, and in examples where ONU 10A is external to the customer premises, ONU 10A may be configured to maintain the average power and extinction ratio to within the desirable range over the industrial temperature range (e.g., −40° C. to +85° C.). In examples where ONU 10A is within the customer premises, ONU 10A may not experience such large variation in temperatures. However, because the temperature range within the customer premises will be within the −40° C. and +85° C. range, ONU 10A may be configured to maintain the average power and the extinction ratio to desirable levels for the temperature range within the customer premises.

It should be understood that the −40° C. to +85° C. temperature range is provided for purposes of illustration. For example, ONU 10A may be configured to maintain the average power and the extinction ratio for a wider temperature range (e.g., less than −40° C. to greater than +85° C.), a narrower temperature range (e.g., greater than −40° C. and less than +85° C.), or any combination of maximum and minimum temperatures.

As described in more detail, transmitter 14A may include an optical driver, such as a laser driver, and an optical source, such as the laser. In general, off-the-shelf laser drivers (i.e., commonly available laser drivers) are configured to maintain the average power output by the laser, and function fairly well in maintaining the average power output by the laser over a wide range of temperature. However, testing showed that most off-the-shelf laser drivers function poorly in maintaining the extinction ratio. For example, for the 700 series optical network terminals (ONTs), which may be one example of ONU 10A, by Calix Inc. of Petaluma, Calif., the laser drivers functioned well at maintaining the average power, but functioned poorly at maintaining the extinction ratio within specifications over a wide temperature range.

For extinction ratio management, ONU 10A may include a control unit. As described in more detail, the control unit of ONU 10A may maintain the extinction ratio to overcome the deficiencies of the laser drivers. For example, the control unit may determine the instantaneous slope efficiency of the laser, while the laser is generating optical signals to transmit optical data. Based on the determined slope efficiency, the control unit may determine the current levels for the digital ones and digital zeros needed to maintain the extinction ratio to within desirable levels. The control unit may then cause the laser driver of transmitter 14A to cause the determined current levels to flow through the laser, thereby ensuring that the extinction ratio is within the desirable range.

In some examples, the control unit of ONU 10A may be hardwired to perform the functions for maintaining the extinction ratio. In other examples, the control unit of ONU 10A may execute software that causes the control unit to perform the functions for maintaining the extinction ratio. Using a hardware-based control unit to perform these functions (e.g., where the control unit is hardwired to perform these functions) may require a truck-roll to the customer premises to either replace the current control unit with the new hardware-based control unit, or to replace the current ONU 10A with a new ONU that includes the hardware-based control unit. However, by loading ONU 10A with software that causes the control unit to perform the functions for maintaining the extinction ratio, it may be possible to update legacy control units to perform the functions. This may reduce the amount of replacement of the control unit or of ONU 10A, which may be a cheaper option.

The techniques described in this disclosure may provide additional benefits as compared to some other techniques for maintaining the average power and the extinction ratio. For instance, some other techniques may utilize a predetermined equation that estimates the current needed to maintain the extinction ratio. One example of such a predetermined equation is in Agrawal (ISBN 0-471-21571-6), the contents of which are incorporated by reference in their entirety. The Agrawal equation predicts the threshold current, as a function of temperature, as I_{threshold}(T)=I₀*e^{T/To}, where I₀ is based on the laser hardware and T₀ is a curve-fitting parameter. To improve accuracy in some cases, the Agrawal equation may be bifurcated for temperatures above and below 25° C. For example, for T≧25° C., I₀*e^{T/To}, and for T<25° C., I₁*e^{T/T1}, where T₀ and T₁ are curve-fitting parameters, and I₀ and I₁ are adjusted to provide continuity at T equals 25° C.

However, there may be large variations in the amount by which the slope efficiency changes, as a function of temperature, for different lasers (i.e., there are large unit-to-unit variations). Accordingly, the predetermined equation may function well for some lasers, and not well for others resulting in some ONUs that are not well suited to maintain the extinction ratio. For example, for some lasers, the predetermined equation may determine current levels that cause the amount of current flowing through the laser to fall below the threshold current causing the laser to turn off completely and may result in unpredictable performance because of the uncertainties in the laser turn-on time.

In yet some other techniques, the manufacturer cycles through temperature and determines the specific temperature characteristics of each laser. For example, the manufacturer measures the slope efficiency at various temperatures, and creates a look-up table that indicates the slope efficiency at the various temperatures. The manufacturer then loads the look-up table in the ONU, and the ONU sets the amount of current that flows through the laser based on the look-up table. While this other technique removes the unit-to-unit variability of the laser, this other technique requires cycling through a wide range of temperatures for each laser, and creating a look-up table for each laser. Such cycling through the wide range of temperatures is expensive, and hence, undesirable.

The techniques described in this disclosure allow for an on-the-fly determination of the slope efficiency (e.g., while the laser is transmitting the optical signal from the customer premises), and allow for an adjustment of the current that flows through the laser while the laser is transmitting the optical signal. Accordingly, the techniques described in this disclosure may remove unit-to-unit variability of the laser because the techniques adjust the current for the specific laser in operation. The techniques described in this disclosure may not require the generation of the look-up table, as the adjustment is performed on-the-fly based on determination of the instantaneous (e.g., present) slope efficiency of the laser.

The manner in which the techniques are implemented in described in more detail. First, however, the following is a description of lasers to further assist with the understanding of the techniques.

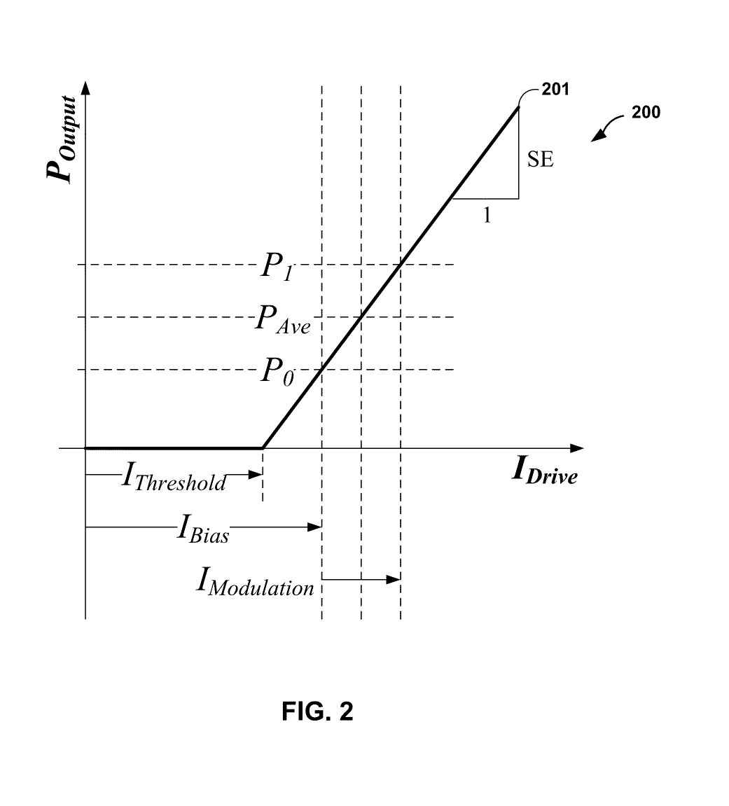

FIG. 2 is a graph illustrating various concepts related to driving a laser system. Graph 200 includes plot 201 illustrating a transfer function of an example laser. The x-axis (horizontal axis) of graph 200 corresponds to the drive current (I_{Drive}) passed through the example laser (i.e., the amount of current that flows through the laser). In some examples, the drive current may be composed of two currents, a bias current (I_{Bias}) and a modulation current (I_{Modulation}). The y-axis (vertical axis) of graph 200 corresponds to the power output (P_{Output}) by the example laser in response to the drive current.

The threshold current level, illustrated by “I_{Threshold}” of graph 200, is the level of drive current which may be passed through the laser to initiate lasing. When the drive current is greater than the threshold current level, the laser may output coherent laser light power. When the drive current is less than the threshold current level, the laser may not output coherent power but emits un-coherent light (i.e., like a Light Emitting Diode, or L.E.D.). When a drive current switches from being less than the threshold current to greater than the threshold current, the time until lasing is initiated may be unpredictable. Such unpredictability may result in a phase- or time-distorted bit pattern, which may result in bit errors. Accordingly, the techniques described in this disclosure may ensure that the drive current (i.e., the combination of the bias current and the modulation current) is not less than the threshold current, and in some examples, may ensure that the bias current is not less than the threshold current.

As described above, optical signals, such as GPON optical signals, may convey information in the form of bits. Binary optical bits are differentiated by determining the presence of optical power at two different levels. Arbitrarily, a binary “0” is assigned to a relatively low power level called P0. A binary “1” is assigned to a relatively high power level called P1.

The bias current, illustrated by “I_{Bias}” of graph 200, is the level of drive current which may be passed through the laser during transmission of a first logic level (i.e., a “0” level) where the laser driver is DC-coupled to the laser. In some examples, certain types of phase- or time-distortion of the bit pattern may be avoided by maintaining the bias current at a level greater than the threshold current level. The phase- or time-distortion of the bit pattern may be evident in an eye pattern.

The eye pattern may be considered as a graphical representation of the data transmitted by transmitter 14A, where the level of the bits (e.g., digital ones and digital zeros) in the data are overlaid on top of one another causing the graphical representation to appear as an “eye.” This eye pattern, or eye diagram, provides a visual indication of the quality of the optical signal transmitted by the laser of transmitter 14A. For example, if the drive current falls to less than the threshold current, the eye diagram may become time-distorted indicating that the drive current has fallen below the threshold current, and the eye may appear to close, horizontally. If the extinction ratio becomes too small, the eye diagram may appear to close, vertically. Constructing eye diagrams may provide a useful manner in which to test the functionality of transmitter 14A.

It should be understood that the description of the eye pattern or eye diagram is provided to ease with understanding. In the techniques described in this disclosure, ONU 10A may control the functionality of transmitter 14A during operation (e.g., when transmitter 14A is transmitting information) and after any testing performed at the manufacturer. The techniques described in this disclosure may not require the formation of an eye pattern or eye diagram for functionality.

In some examples, such as where the laser driver is AC-coupled to the laser, the bias current may be defined as the current used to set an average output power level. While the techniques described in this disclosure are equally applicable to either definition, for convenience, this disclosure will refer to the bias current as the level of drive current which may be passed through the laser during transmission of a 0 level (i.e., the digital zero). As described above, in these cases, the laser driver is DC-coupled to the laser.

The modulation current, illustrated by “I_{Modulation}” of graph 200, is the level of drive current which may be passed, in addition to the bias current, through the laser during transmission of a second logic level (i.e., a “1” level). In other words, the modulation current may set the difference between the “0” and “1” levels.

As shown by graph 200, “P0” illustrates the power output of the laser at a first logic level, such as where the drive current equals the bias current (i.e., where I_{Drive}=I_{Bias}, P_{Output}=P₀). As shown by graph 200, “P1” illustrates the power output of the laser at a second logic level, such as where the drive current equals the bias current plus the modulation current (i.e., where I_{Drive}=I_{Bias}+I_{Modulation}, P_{Output}=P₁).

As shown by graph 200, “Pave” illustrates the average power output of the laser, such as the average power output of the laser over a period in which equal quantities of “0”s and “1”s were transmitted. For instance, if the laser transmits an equal number of digital zeros and digital ones, the average output power may be approximately the average of P1 and P0. However, if the laser outputs more digital ones than digital zeros, then the average power may be biased towards P1, and if the laser outputs more digital zeros than digital ones, then the average power may be biased towards P0. For purposes of illustration, it is assumed that the laser outputs equal number of digital ones and digital zeros over a period resulting in the average power being an average of P1 and P0. Average power is useful because it is easily measured accurately using readily available inexpensive optical power meters.

As shown by graph 200, “SE” illustrates the slope efficiency of the laser. The slope efficiency of a laser may be defined as the slope of plot 201 for drive currents greater than the threshold current level. The slope efficiency may be determined in accordance with the following equation (1):

$$SE = \frac{Δ {P}_{Ave}}{Δ {I}_{Drive}} . \qquad ( 1 )$$

In accordance with equation (1) and the above description of drive current, where either the bias current or the modulation current is held constant, the slope efficiency may be determined with two distinct average power values and a bias current or a modulation current value for each average power value. For example, it may be possible to set the average power to a first average power level, and determine a first drive current. Then, set the average power to a second average power level, and determine a second drive current. The slope efficiency may then be (first average power level minus second average power level) divided by (first drive current minus second drive current).

The extinction ratio (ER) may be defined as the ratio of the power output of the laser at a second logic level to the power output of the laser at a first logic level. The ER is an important number because large separations between the P1 and P0 levels can cause the spectral width of the output power to increase. This phenomenon is referred to as chirp and may have an impact on the dispersion performance of optical systems. In a GPON system, such as the example network system of FIG. 1, the ER may be maintained within a range of 8.2 dB to 15 dB. The ER may be determined in accordance with the following equation (2):

$$ER = \frac{{P}_{1}}{{P}_{0}} . \qquad ( 2 )$$

In accordance with the techniques described in this disclosure, the control unit of ONU 10A may determine the slope efficiency of the laser during operation. For example, the control unit may receive a measure of the present average power output by the laser and the current level of at least one of the bias or modulation currents. The control unit may then cause the laser driver of transmitter 14A to adjust the average power output by the laser from the present power level to a new power level.

For example, as described in more detail, the laser driver of transmitter 14A may include an input that allows the control unit to set the average power of the laser to a desired level (e.g., to the new power level). In turn, the laser driver adjusts the current level of at least one of the bias current or the modulation current so that the average power level output by the laser is equal to the average power level set by the control unit. For instance, the laser driver includes an automatic power control (APC) loop that receives the average value of feedback current. The feedback current is indicative of the average power output by the laser, and is generated by a photodiode which receives a fraction of the laser output power. The APC loop of the laser driver adjusts the current level of at least one of the bias current or the modulation current until the feedback current indicates that the average power output by the laser is equal to the average power level set by the control unit.

When the laser outputs the optical signal at the new average power level, the laser driver may output to the control unit a new current level of at least one of the bias current and the modulation current. Based on the current levels driven when the laser is outputting at the new average power level and the previous average power level, the control unit may determine the slope efficiency of the laser. The control unit may determine the current level of at least one of the bias current and the modulation current needed to achieve the desired extinction ratio. The control unit may then cause the laser driver to flow current through the laser at the determined current level to achieve the desired extinction ratio.

FIG. 3 is a graph illustrating optical output power versus drive current and ambient temperature for an example laser. The plots of FIG. 3 illustrate the slope efficiency and threshold currents at different ambient temperatures. While the plots of FIG. 3 are illustrated as being linear, it is understood that the slope efficiencies of some lasers may include non-linear features, although the slope efficiencies are generally linear.

As illustrated in FIG. 3, the slope efficiency and threshold current of a laser is influenced by the ambient temperature. Table 1 below shows approximate values for the slope efficiency and threshold current for each of the plots illustrated in FIG. 3. As shown in Table 1, as the ambient temperature increases, there is a corresponding decrease of the slope efficiency and a corresponding increase of the threshold current. Also, as the ambient temperature decreases, there is a corresponding increase of the slope efficiency and a corresponding decrease of the threshold current.

TABLE 1

| | | Threshold Current |
|---|---|---|
| Temperature (° C.) | Slope Efficiency (mA/mW) | (mA) |
| −40 | 0.22 | 2.65 |
| 0 | 0.20 | 3.65 |
| 25 | 0.15 | 5.14 |
| 85 | 0.12 | 15.55 |
| 95 | 0.08 | 22.33 |
| 110 | 0.06 | 34.41 |
| 120 | 0.05 | 45.88 |

Additionally, the transfer function and associated parameters of a laser may change as the laser ages. In some cases, the slope efficiency of a laser at a fixed temperature may decrease over time. In some cases, the threshold current of a laser may increase over time.

Moreover, FIG. 3 illustrates the changes in the slope efficiency and threshold current for one laser as a function of ambient temperature. The changes in the slope efficiency and threshold current, as a function of ambient temperature, for different lasers may be different. The techniques described in this disclosure may provide for on-the-fly adjustment to the current flowing through the laser to maintain the extinction ratio and the average power output by the laser. This may allow for more accuracy in maintaining the average power and extinction ratio to the desired range, without needing extensive testing to compensate for the unit-to-unit variations.

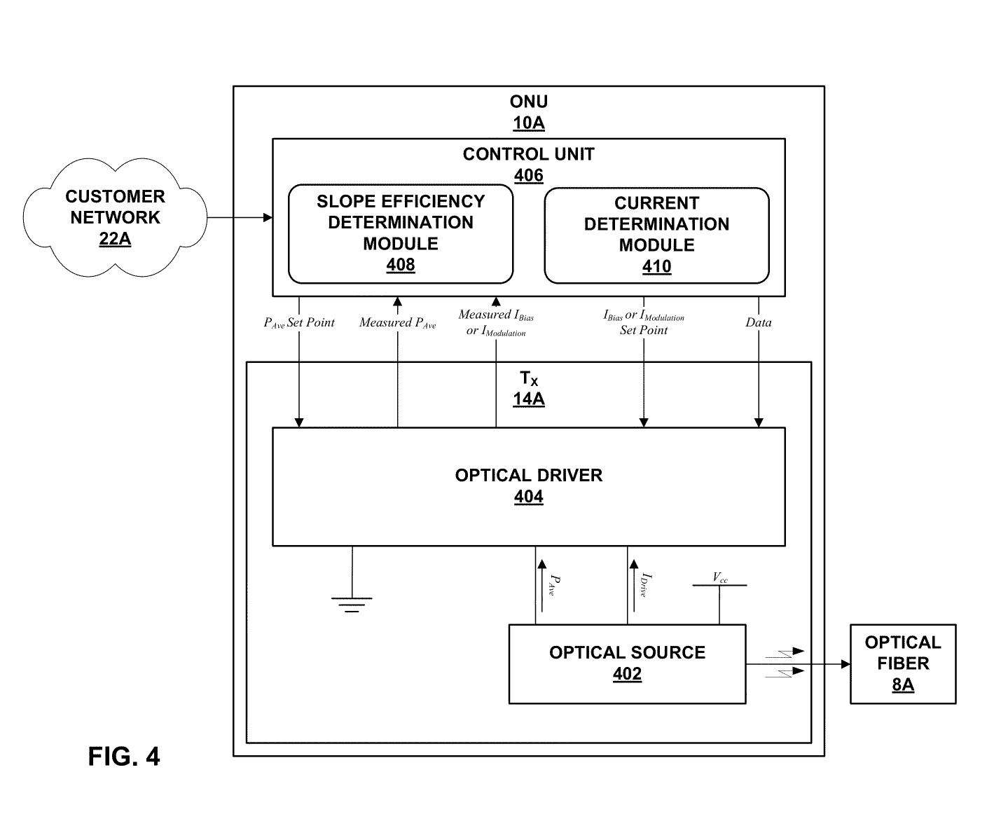

FIG. 4 is a block diagram illustrating example ONU 10A shown in FIG. 1 in more detail. FIG. 4 illustrates one example of ONU 10A and other examples of ONU 10A may be used in other instances. Moreover, the various aspects of the techniques described in this disclosure with respect to ONU 10A may be performed by any type of device and should not be limited to the specific device, i.e., ONU 10A, as shown in the example of FIGS. 1 and 4. To illustrate, an OLT may perform the operations described as being performed by ONU 10A. Thus, while specific examples are shown in FIG. 4, the techniques may be performed by various other types of devices and should not be limited to the example of FIGS. 1 and 4.

As shown in the example of FIG. 4, ONU 10A may include transmitter 14A and control unit 406. Receiver 12A is not shown for ease of illustration. Transmitter 14A may include optical source 402 and optical driver 404. Control unit 406 may include slope efficiency determination module 408 and current determination module 410. Examples of optical driver 404 include, but are not limited to, the MAX3710 by Maxim Integrated Products, the M02090 by MINDSPEED, and the VSC7967 by Vitesse.

Control unit 406 represents a collection of hardware components, which in some instances executes software in the form of instructions stored to a computer readable medium (including a non-transitory computer-readable medium), to implement the techniques of this disclosure. For example, control unit 406 may comprise any combination of one or more of processors, application specific integrated circuits (ASICs), field programmable gate arrays (FPGAs), integrated circuits or any other processing or control element or combination thereof. Control unit 406 may also comprise memory, both static (e.g., hard drives or magnetic drives, optical drives, FLASH memory, EPROM, EEPROM, etc.) and dynamic (e.g., RAM, DRAM, SRAM, etc.), or any other non-transitory computer readable storage medium capable of storing instructions that cause the one or more processors to perform the efficient network management techniques described in this disclosure. These instructions may form a computer or software program or other executable module that the programmable processor executes to perform the functionality described herein, including the functionality attributed to the techniques of this disclosure.

Optical source 402 may be configured to transmit an optical signal into an optical medium, such as optical fiber link 8A. Optical source 402 may include a laser, a laser diode, a light emitting diode, or any other type of device that can transmit an optical signal. For purposes of illustration, optical source 402 is assumed to be a laser. Optical source 402 may be configured to transmit an optical signal in response to a drive current flowing through optical source 402. In some examples, the drive current (i.e., I_{Drive}) flows from a power source (i.e., V_{cc}), through optical source 402 and into optical driver 404 before reaching ground. Optical driver 404 may be an example of a laser driver. Optical source 402 may be configured to output a signal corresponding to the average power of the transmitted optical signal (P_{Ave}). In some examples, optical source 402 is configured to transmit an amplitude modulated optical signal with a wavelength at or around 1310 nm. In other examples, optical source 402 is configured to transmit an optical signal at other wavelengths.

Optical driver 404 may be configured to control the level of current flowing through an optical source, such as optical source 402. Optical driver 404 may be configured to control the level of drive current flowing through optical source 402 (i.e., I_{Drive}) by controlling a bias current component and a modulation current component of the drive current. In some examples, optical driver 404 may be configured to control the drive current in response to a data signal (i.e., Data) received from control unit 406. Where the received data signal indicates a “0” value (i.e., a digital zero), optical driver 404 may adjust the drive current such that the drive current includes the bias current component, and no modulation current component. Where the received data signal indicates a “1” value (i.e., a digital one), optical driver 404 may adjust the drive current such that the drive current includes the bias current component and the modulation current component.

In some examples, optical driver 404 may be configured to receive a bias current set point and set the bias current level to the received bias current set point. For instance, optical driver may receive a bias current set point (i.e., I_{Bias} Set Point) from control unit 406. In some examples, optical driver 404 may be configured to receive a modulation current set point and set the modulation current level to the received modulation current set point (i.e., I_{Modulation} Set Point). In some examples, optical driver 404 may be configured to output a signal corresponding to the level of drive current flowing through optical source 402 to control unit 406.

For instance, optical driver 404 may output a signal corresponding to the level of the modulation current or the bias current to control unit 406 (i.e., Measured I_{Bias} or I_{Modulation}). In other words, optical driver 404 may output a current level of at least one of the bias current or the modulation current that is flowing through optical source 402. The output of the current level of at least one of the bias current or the modulation current may be a measure of the instant amount of bias current or modulation current that is flowing through optical source 402.

Optical driver 404 may be configured to receive an average power set point and maintain the average power level of the optical signal transmitted by optical source 402 at or around the received average power set point. For instance, optical driver 404 may receive an average power set point (i.e., P_{Ave} Set Point) from control unit 406.

Also, optical driver 404 is configured to receive a signal corresponding to the average power of the optical signal transmitted by optical source 402. For instance, optical driver 404 may receive a current corresponding to the average power of the optical signal transmitted by optical source 402 (i.e., P_{Ave}) from optical source 402.

In some examples, optical driver 404 maintains the average power level of the optical signal by modifying a modulation current component of the drive current flowing through optical source 402. For instance, optical driver 404 may include a hardware based control loop to control the modulation current, referred to as the automatic power control (APC) loop. In other examples, optical driver 404 maintains the average power level of the optical signal by modifying a bias current component of the drive current flowing through optical source 402. For instance, optical driver 404 may include a hardware based feedback loop to control the bias current. In some examples, optical driver 404 may be configured to output a signal corresponding to the average power of the optical signal transmitted by optical source 402. For instance, optical driver 404 may output a signal corresponding to the average power of the optical signal transmitted by optical source 402 (i.e., Measured P_{Ave}) to control unit 406.

Slope efficiency determination module 408 of control unit 406 may represent a module configured to determine an estimate of a slope efficiency of optical source 402. In some examples, slope efficiency determination module 408 may determine an estimate of a slope efficiency of optical source 402 while optical source 402 is generating optical signals to transmit the optical data. Slope efficiency determination module 408 may be configured to adjust the average power of the optical signal transmitted by optical source 402 by outputting an average power set point. For instance, slope efficiency determination module 408 may output an average power set point (i.e., P_{Ave} Set Point) to optical driver 404. Slope efficiency determination module 408 may be configured to receive a signal corresponding to the average power of the optical signal transmitted by optical source 402. For instance, slope efficiency determination module 408 may receive a signal corresponding to the average power of the optical signal transmitted by optical source 402 (i.e., Measured P_{Ave}) from optical driver 404. Slope efficiency determination module 408 may be configured to receive a signal corresponding to the level of current flowing through optical source 402. For instance, slope efficiency determination module 408 may receive a signal corresponding to the level of the modulation current or the bias current (i.e., Measured I_{Bias} or I_{Modulation}) from optical driver 404. In some examples, the estimate of the slope efficiency is determined based on an adjustment of the average power and a determined change in current flowing through the laser.

For example, control unit 406 may output a first Pₐᵥₑ Set Point that causes optical driver 404 to cause optical source 402 to transmit the optical signal at a first average power level. In response, slope efficiency determination module 408 may read the measure of the first average power level as output by optical driver 404, and read the measure of the first current level when the optical driver 404 is transmitting the optical signal at the first average power level.

Then, while the laser is outputting the data, control unit 406 may output a second Pₐᵥₑ Set Point that causes optical driver 404 to cause optical source 402 to transmit the optical signal at a second average power level. In response, slope efficiency determination module 408 may read the measure of the second average power level as output by optical driver 404, and read the measure of the second current level when the optical driver 404 is transmitting the optical signal at the second average power level.

Slope efficiency determination module 408 may determine a delta between the first average power level and the second average power level, and may determine a delta between the first current level and the second current level. Slope efficiency determination module 408 may divide the delta of the average power levels by the delta of the current levels. The result of the division is the instant slope efficiency of optical source 402.

Slope efficiency determination module 408 may be configured to send the determined estimate of the slope efficiency to current determination module 410. Current determination module 410 of control unit 406 may represent a module configured to determine an updated first current level based on the estimate of the slope efficiency received from slope efficiency determination module 408. Current determination module 410 may be configured to receive a signal corresponding to the level of current flowing through optical source 402. For instance, current determination module 410 may receive a signal corresponding to the level of the modulation current or the bias current (i.e., Measured I_{Bias} or I_{Modulation}) from optical driver 404. Current determination module 410 may be configured to receive a signal corresponding to the average power of the optical signal transmitted by optical source 402. For instance, current determination module 410 may receive a signal corresponding to the average power of the optical signal transmitted by optical source 402 (i.e., Measured P_{Ave}) from optical driver 404. In some examples, current determination module 410 may be configured to output the determined updated first current level. For instance, current determination module 410 may output bias current set point (i.e., I_{Bias} Set Point) to optical driver 404.

In this way, optical driver 404, which may be an off-the-shelf laser driver, may maintain constant average power using its feedback control loop, which may be implemented as hardware or software. For instance, optical driver 404 may receive feedback current from optical source 402 indicative of the average power output by optical source 402. In some examples, the housing of optical source 402 may include a back-facet monitor photodiode. The monitor photodiode may receive a portion of the optical power output by optical source 402, and may output a current indicative of the average power output by optical source 402.

For example, the monitor photodiode may be a low bandwidth photodiode in that the bandwidth of the current that the monitor photodiode outputs may be substantially less than the bandwidth of the optical signal that optical source 402 outputs (i.e., the bandwidth of the current that the monitor photodiode outputs does not have the same bandwidth of the output optical signal that optical source 402 outputs). Because the bandwidth of the current that the monitor photodiode outputs is substantially less than the bandwidth of the optical signal that optical source 402 outputs, the current output by the monitor photodiode may be indicative of the average power output by optical source 402 and not the actual power levels of the digital highs and digital lows output by optical source 402. In accordance with the techniques this disclosure, the current output by the monitor photodiode may be the feedback current that optical driver 404 receives.

Furthermore, the feedback control loop of optical driver 404 may also be low bandwidth. For example, the feedback control loop of optical driver 404 may function as a low-pass filter that low-pass filters the feedback current, thereby further reducing the bandwidth of the feedback current. In this way, the output of the feedback control loop of optical driver 404 may provide a measure of the average power output by optical source 402.

Optical driver 404 may also receive an average power set point from control unit 406. Optical driver 404 may modify the drive current (e.g., at least one of the bias current and modulation current) that flows through optical source 402 until the feedback current from optical source 402 indicates that the average power output by optical source 402 is equal to the average power set by control unit 406. This functionality of optical driver 404 may be occurring continuously while optical source 402 is transmitting optical signals based on the data received from customer premises equipment of customer network 22A.

When optical source 402 is transmitting the optical signal, optical source 402 may be transmitting the optical signal with an average power at a first average power level. For example, control unit 406 may set the average power of the optical signal and at least one of the bias current level and modulation current level, and optical driver 404 may adjust at least one of the bias current level and modulation current level so that optical source 402 outputs the optical signal at the first average power level.

Then, while optical source 402 is transmitting the optical signal, control unit 406 may perturb the average output power level and may receive a measure of the change in the drive current required to cause optical source 402 to output the optical signal at the perturbed average output power level. For example, slope efficiency determination module 408 may output a P_{Ave} Set Point value that instructs optical driver 404 to set the average power of the optical signal at a second, different average power level. This adjustment in the average power level from the first average power level to the second, different average power level may be considered as perturbation of the average output power level.

In response to the perturbation, optical driver 404 may cause optical source 402 to transmit the optical signal at the second average power level. For example, optical driver 404 may adjust the drive current level (e.g., at least one of the bias current level or the modulation current level) until the feedback loop of optical driver 404 determines that the average power output by optical source 402 is equal to the second average power level.

In addition, when optical source 402 is outputting the optical signal at the first average power level, slope efficiency determination module 408 may receive a measure of the drive current (e.g., at least one of the bias current level or modulation current level) flowing through optical source 402. This measure of drive current may be referred to as a first drive current level. Then, when optical source 402 is outputting the optical signal at the second average power level, slope efficiency determination module 408 may receive a measure of the drive current, which is at a second drive current level because optical source 402 is outputting the optical signal at a second, different average power level.

From the first and second average power levels and the first and second drive current levels, slope efficiency determination module 408 may determine the slope efficiency of optical source 402. For example, the slope efficiency of optical source 402 may equal (first average power level minus second average power level) divided by (first drive current level minus second drive current level). Because slope efficiency determination module 408 may determine the slope efficiency of optical source 402 at the present ambient temperature (i.e., the ambient temperature within which optical source 402 is operating), slope efficiency determination module 408 may determine the instant slope efficiency of optical source 402 while optical source 402 is transmitting the optical signal representing the data from the CPE of customer network 22A.

Based on the determined slope efficiency, current determination module 410 may determine an updated drive current value. For example, in examples where control unit 406 sets the bias current level, and optical driver 404 adjusts, via the feedback loop, the modulation current level to achieve the desired average output power level, current determination module 410 may determine an updated bias current. Again, the drive current includes the bias current and modulation current. Accordingly, in examples where optical driver 404 is configured to adjust the modulation current component of the drive current to maintain the average power, current determination module 410 may determine an updated bias current level that ensures that the “0” level (e.g., optical power for the digital low) of the optical signal is greater than or equal to the threshold current. In accordance with the techniques described in this disclosure, when optical source 402 is driven at the updated bias current level and at the modulation current level determined by the feedback loop of optical driver 404, the extinction ratio of the optical signal transmitted by optical source 402 is within the acceptable range.

In some examples, rather than controlling the modulation current level, optical driver 404 may be configured to control the bias current level to achieve the desired average output power level. For example, control unit 406 may set the modulation current level of the modulation current that optical driver 404 flows through optical source 402. In this example, the feedback loop of optical driver 404 may adjust the bias current level to ensure that the average power output by optical source 402 is within the desirable range. In these examples, current determination module 410 may determine an updated modulation current level that ensures that the “0” level of the optical signal is greater than or equal to the threshold current. In these examples, when optical source 402 is driven at the updated modulation current level and at the bias current level determined by the feedback loop of optical driver 404, the extinction ratio of the optical signal transmitted by optical source 402 is within the acceptable range.

As described above, the techniques in this disclosure determine the drive current needed to maintain the extinction ratio for the present ambient temperature. However, as the ambient temperature changes, control unit 406 may periodically determine the drive current (e.g., at least one of the bias or modulation current components) needed to maintain the extinction ratio. For example, control unit 406 may determine the drive current needed to maintain the extinction ratio every 10 minutes, although other periods are possible, and in some examples may be based on the thermal time constant of ONU 10A.

Although the ambient temperature changes, the ambient temperature may not change quickly. Therefore, determining the drive current every 10 minutes may be sufficient to ensure that the extinction ratio is maintained, even in environments where there the ambient temperature changes, such as at the outside of the subscriber premises. Furthermore, because the ambient temperature changes relatively slowly, control unit 406 may be able to execute software to determine the drive current. For example, if the temperature changes were very fast, then the software executing on control unit 406 may not be able to determine the needed drive current to maintain the extinction ratio fast enough to keep with the changes in the ambient temperature. Because ambient temperature changes relatively slowly, control unit 406 may be able to execute software to implement the techniques described in this disclosure, which in turn may also allow for legacy control units to be updated with the software needed to implement the techniques described in this disclosure.

Moreover, as described above, as part of the techniques to determine the drive current, control unit 406 may cause optical driver 404 to perturb (e.g., adjust) the average optical power output by optical source 402. Control unit 406 may perturb the average power while optical source 402 is outputting the optical signal. Accordingly, if the perturbation is too large, then the perturbation may introduce bit errors. At the same time, if the perturbation is too small, there may not be sufficient change in the average power to accurately determine the slope efficiency (from which control unit 406 determines the needed drive current). Accordingly, control unit 406 may select the amount of adjustment of the average optical power output by optical source 402 such that the perturbation is small enough as to not induce bit errors and large enough that an accurate estimate of the slope efficiency can be calculated.

For example, control unit 406 may adjust the average power output by optical source 402 such that the average power output by the optical source 402 is within the power range specified by a standard (such as the GPON standard). The GPON standard defines the output average power range to be between 0.5 dBm and 5 dBm. In some examples, the manufacturing calibration error of optical source 402 may be ±0.25 dB, and the tracking error may be ±1.5 dB. Therefore, GPON provides a total error budget of 4.5 dB (i.e., 5 dBm minus 0.5 dBm). Of that 4.5 dB, 3.5 dB is lost to account for the tracking and calibration errors. For example, at one end of the tracking error range, the tracking error is −1.5 dB and at one end of the calibration error, the calibration error is −0.25 dB. Accordingly, the combination of these ends of the error is −1.75 dB. At the other end, the tracking error is 1.5 and the calibration error is 0.25, for a combination of 1.75 dB. The range of −1.75 dB to 1.75 dB is 3.5 dB.

In this example, the amount by which control unit 406 can adjust the average optical power output by optical source 402 can be in the range of 1 dB. For instance, of the allowable GPON average power range of 4.5 dB, 3.5 dB is lost to account for calibration and tracking error, leaving 1 dB for the perturbing average power adjustment.

As described above, in some examples, optical driver 404 may be configured to implement a feedback loop by which optical driver 404 keeps the bias current constant and modifies the modulation current to achieve the desired average power output by optical source 402. In these examples, control unit 406 may determine the bias current needed to maintain the extinction ratio. In other examples, optical driver 404 may be configured to implement a feedback loop by which optical driver 404 keeps the modulation current constant and modifies the bias current to achieve the desired average power output by optical source 402. In these examples, control unit 406 may determine the modulation current needed to maintain the extinction ratio.

For purposes of illustration, the techniques are described with examples where control unit 406 determines the bias current needed to maintain the extinction ratio, followed by examples where control unit 406 determines the modulation current needed to maintain the extinction ratio. For example, control unit 406 may first determine the instant slope efficiency. In the slope efficiency determination process, optical driver 404 may keep the bias current constant.

To determine the slope efficiency, slope efficiency determination module 408 may read the present modulation current required to generate the present average power output of optical source 402. For example, in operation, optical driver 404 may cause a certain amount of bias and modulation current to flow through optical source 402, causing optical source 402 to output the optical signal at a certain average power. In some examples, the average power may be approximately 2.5 dBm. In this example, the present modulation current may be referred to as a first modulation current level, and the present average power output may be referred to as a first average power output level.

Slope efficiency determination module 408 may adjust the average power output by optical source 402 from the first average power output level to a second average power output level. For example, slope efficiency determination module 408 may have output a first Pave Set Point value to optical driver 404, which caused optical driver 404 to output optical power at the first average power output level. Slope efficiency determination module 408 may output a second Pave Set Point value to optical driver 404, which causes optical driver 404 to output optical power at the second average power output level.

The feedback loop (e.g., the APC loop) of optical driver 404 may then adjust the modulation current level so that optical source 402 outputs the optical power at the second average power level. For example, optical driver 404 may have caused modulation current at a first modulation current level to flow through optical source 402 to cause optical source 402 to output at the first average optical power level. Then, in response to an adjustment to the average power level output by optical source 402, optical driver 404 may adjust the modulation current so that optical source 402 outputs at the second average power level.

Once the average power level stabilizes to the second average power level, slope determination module 408 may read the present modulation current (referred to as the second modulation current), where the present modulation current causes optical source 402 to output at the second average power level. Slope determination module 408 may then determine the instant slope efficiency as (second average power level−first average power level)/(second modulation current level−first modulation current level).

After slope efficiency determination module 408 determines the present slope efficiency, current determination module 410 may determine the bias current needed to maintain the extinction ratio. For example, ideally the optical power of the digital zero should be equal to the power level output by optical source 402 when there is no modulation current (e.g., the drive current flowing through optical source 402 equals only the bias current flowing through optical source 402). However, after optical driver 404 causes bias current at an initial bias current level to flow through optical source 402, due to laser-to-laser variation, temperature changes, and laser aging, there is an error in the bias current from the present level (e.g., initial level) and the bias current level where the extinction ratio is within the desirable range. This error in the bias current may be referred to as ΔIbias.

Because the feedback loop of optical driver 404 controls the average output power (Pave) and Ibias is fixed, optical driver 404 may adjust the modulation current (Imod) to compensate for the error in the Ibias. While this change maintains the correct Pave, the existence of ΔIbias means that the optical power level for transmitting the digital zero is incorrect, which means that the extinction ratio is incorrect. To address this, current determination module 410 may change the present Ibias level by ΔIbias.

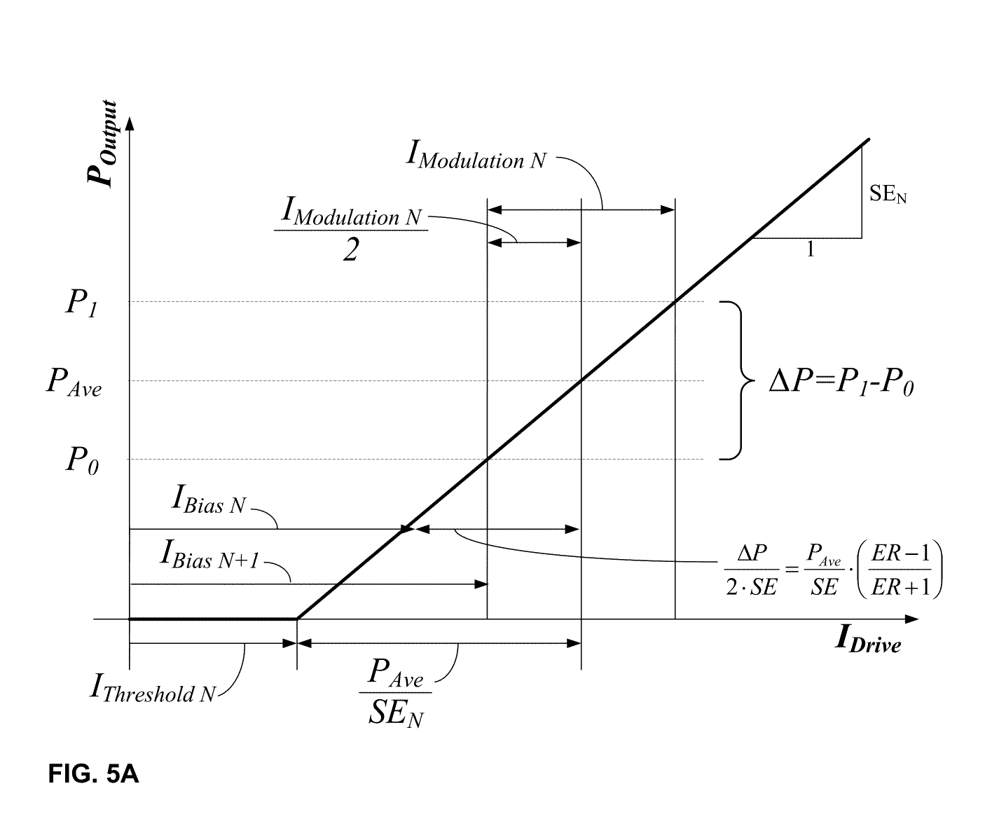

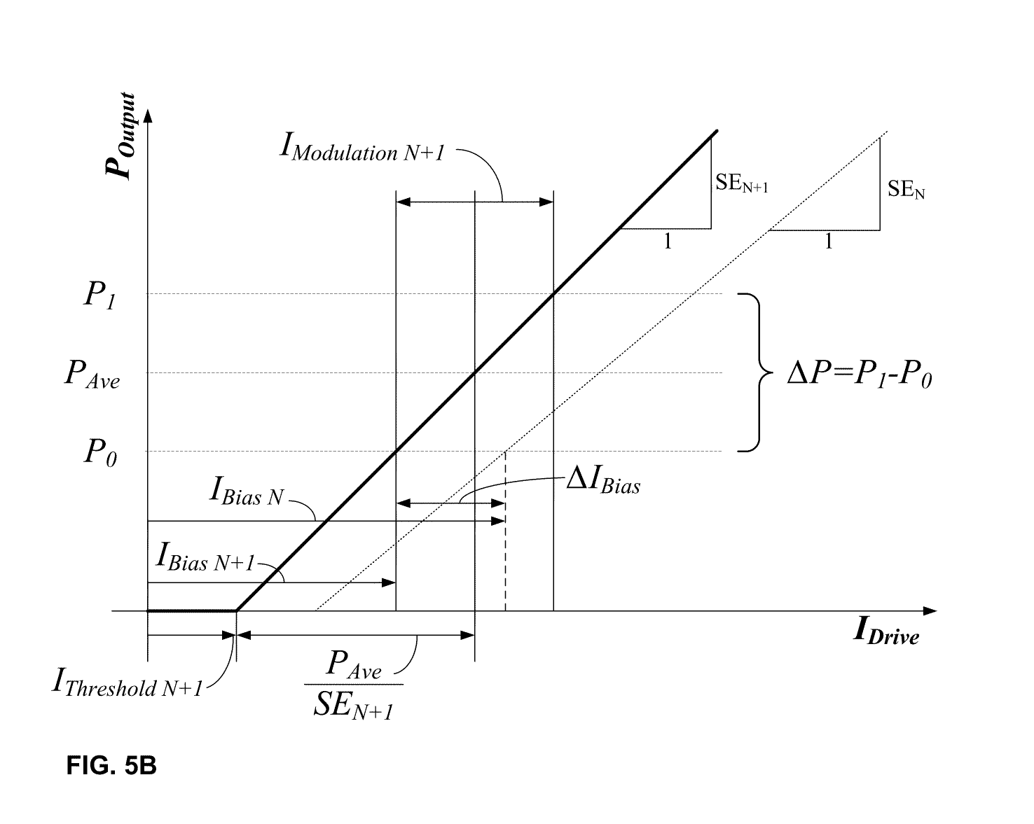

FIG. 5A is a graph illustrating parameters of an example ONU, such as ONU 10A of FIG. 4 where the first current is a bias current, where the parameters have shifted and the bias current needs to be corrected in accordance with one or more techniques of the present disclosure. For example, FIG. 5A illustrates the values needed for control unit 402 to adjust the bias current to maintain the extinction ratio.

As described above, slope efficiency determination module 408 may periodically take samples of the slope efficiency (SE) of optical source 402 and the modulation current values. From these values, current determination module 410 may determine the bias current level needed based on the present bias current level. For example, let N represent the Nth set of slope efficiency and modulation current samples, then N+1 represents the next sample, N+2 represents the sample after that, and so forth.

ΔIbias_{N} may represent the error between Ibias_{N} and where Ibias should be for the proper extinction ratio. Therefore, Ibias_{N}+ΔIbias_{N} equals the desired bias current. In accordance with the techniques described in this disclosure, current determination module 410 may add Ibias_{N} and ΔIbias_{N}, and set that as the Ibias for when slope efficiency determination module 408 next samples the slope efficiency and modulation current. In other words, Ibias_{N+1} equals Ibias_{N}+ΔIbias_{N}.

As described, ΔIbias_{N} is the difference between Ibias_{N+1} and Ibias_{N}. As illustrated in FIG. 5A, ΔIbias_{N} equals Imodulation_{N}/2−(Pave/SE_{N})*((ER−1)/(ER+1)), where SE is the sampled slope efficiency, and ER is the desired extinction ratio. In this example, current determination module 410 may determine the ΔIbias by computing Imodulation_{N}/2−(Pave/SE_{N})*((ER−1)/(ER+1)).

After current determination module 410 determines the ΔIbias, current determination module 410 may determine Ibias_{N+1} as Ibias_{N+1} equals Ibias_{N}+Imodulation_{N}/2−(Pave/SE_{N})*((ER−1)/(ER+1)). Current determination module 410 may then cause optical driver 404 to flow bias current at the Ibias_{N+1} current level. The bias current at the Ibias_{N+1} level set the zero level of the optical signal, which may then maintain the extinction ratio within the desired range.

For instance, control unit 406 may first determine the value of ΔIbias_{N} as being equal to Imodulation_{N}/2−(Pave/SE_{N})*((ER−1)/(ER+1). Then, control unit 406 may determine the bias current needed to maintain the extinction ratio within the desired range. The bias current needed to maintain the extinction ratio may be referred to as Ibias_{N+1}. In this example, control unit 406 may determine the value of Ibias_{N+1} by determining Ibias_{N}+Imodulation_{N}/2−(Pave/SE_{N})*((ER−1)/(ER+1)). Control unit 406 may then cause optical driver 404 to set the bias current level to Ibias_{N+1} (e.g., the bias current that flows through optical source 402).

In some examples, after slope determination module 408 samples the slope efficiency and the modulation current, slope determination module 408 may reset the Pave Set Point to the first Pave Set point. This may cause optical driver 404 to adjust the modulation current flowing through optical source 402 such that the average power output by optical source 402 is equal to the first average power level.

Then, when optical driver 404 sets the bias current level to Ibias_{N+1}, the feedback loop of optical driver 404 may adjust the modulation current that flows through optical source 402 until the average power output by optical source 402 is equal to the first average power level. In this manner, optical driver 404 may maintain the average power output by optical source 402 to the desired level, and control unit 406 may adjust the bias current to maintain the extinction ratio within the desired range.

In testing, these techniques have been demonstrated to work correctly. For example, based on the testing, it may be possible to load legacy control units 406 with software that causes control units 406 to perform the techniques described in this disclosure. Alternatively, it may be possible to develop hardwired control units 406 that implement the techniques described in this disclosure.

There may be certain optional extensions that the techniques described in this disclosure may utilize. These extensions do not necessarily have to be implemented in every example. However, these extensions may potentially provide more accurate estimates of the slope efficiency and the Ibias_{N+1} values.

For instance, in some examples, slope efficiency determination module 408 may obtain, for each average power set point, a plurality of samples of the levels of the first current (e.g., modulation current). For instance, slope efficiency determination module may, while the average power set point is set to the first average power set point, obtain a plurality of samples of the first level of the first current (i.e., [I_{First[1]}, I_{First[2]}, . . . , I_{First[N]}]) and, while the average power set point is set to the second average power set point, obtain a plurality of samples of the second level of the first current (i.e., [I′_{First[1]}, I′_{First[2]}, . . . , I′_{First[N]}]). In some examples, slope efficiency determination module 408 may determine the slope efficiency by determining an average of a plurality of estimates of the slope efficiency (i.e., (SE[1]+SE[2]+ . . . +SE[N])/N).

In some examples, slope efficiency determination module 408 may determine the slope efficiency based at least in part on previous determinations of the slope efficiency. For instance, slope efficiency determination module 408 may base the determination of the slope efficiency in part on a curve, such as a polynomial curve or a spline, which is based on previous determinations of the slope efficiency. In some examples, slope efficiency determination module 408 may extrapolate the slope efficiency from a plurality of estimates of the slope efficiency determined using different perturbation levels. In some examples, slope efficiency determination module 408 may wait for the average power of the optical signal to stabilize at the second average power level after setting the average power set point to the second average power set point. In some examples, slope efficiency determination module 408 may determine the slope efficiency at a predetermined frequency. For instance, slope efficiency determination module 408 may determine the slope efficiency every 5, 10, 15, or 20 minutes. Notwithstanding the determination method, slope efficiency determination module 408 may send the determined slope efficiency to current determination module 410.

In some examples, the techniques described in this disclosure may be extended for other purposes as well. For example, the techniques described in this disclosure may be extended to determining starting current values. For instance, when ONU 10A is reset, ONU 10A requires initial bias and modulation current values. As described above, some proposed techniques describe the manner in which to set the initial values. However, these initial techniques do not perform well due to the large laser-to-laser variation, and over temperature. Testing ONUs 10 over temperature in production is expensive, making it expensive to determine the exact performance of optical source 402 over temperature in production.

In particular, it may be expensive to set the ambient temperature at a first level, and then cycle through different drive current levels and then manually measure the optical power output for each drive current level at each drive current level, followed by repeating the steps for each ambient temperature level. Such cycling and manual measurement may provide for an accurate measure of the changes in the threshold current of optical source 402 but may be very time intensive, and therefore undesirable.

Utilizing the techniques described in this disclosure, it may be possible to determine the manner in which optical source 402 performs over temperature. For example, Pave may equal SE*(Ibias+Imodulation/2−Ithreshold). Simplifying the equation for Ithreshold results in Ithreshold equals Ibias+Imodulation/2−Pave/SE. Optical driver 404 may provide the Ibias, Imodulation, and Pave values to control unit 406. Also, control unit 406 may determine the present slope efficiency (SE) utilizing the techniques described in this disclosure. In this way, the techniques provide for a mechanism of determining Ithreshold without any direct Ithreshold measuring or drive current adjustment.

For example, during production, it may be possible to set at least one of the bias current and the modulation current, and the average power output by optical source 402. Then, the manufacturer of ONU 10A may cycle ONU 10A over temperature. As ONU 10A is being cycled over temperature, control unit 406 may automatically determine the Ithreshold value without needing to directly cycle through the drive current and directly measuring the optical power. For example, at a current ambient temperature, control unit 406 may determine the Ithreshold, which again is equal to Ibias+Imodulation/2−Pave/SE. In this case, control unit 406 may determine the value of SE utilizing the techniques described above. Then, the manufacturer may change the ambient temperature, and control unit 406 may re-determine the Ithreshold value for the new ambient temperature. In this manner, the techniques may provide for a mechanism to accurately determine the Ithreshold value for a given optical source 402 without the need to cycle through drive current levels and directly measuring the optical power.

In the above examples, optical driver 404 adjusted the modulation current to maintain the average power output by optical source 402. In other examples, optical driver 404 may adjust the bias current to maintain the average power output by optical source 402. The techniques described in this disclosure may be extended to such cases as well.

FIG. 5B is a graph illustrating parameters of an example ONU, such as ONU 10A of FIG. 4 where the parameters have shifted and the modulation current needs to be corrected in accordance with one or more techniques of the present disclosure. For example, in examples where optical driver 404 adjusts the bias current, control unit 406 may determine the modulation current needed to maintain the extinction ratio to within the desired range. This modulation current may be represented as Imodulation_{N+1}.

The following equations illustrate that changing the average power produces a change in the bias current. This change in the bias current is related to change in the average power slope efficiency.

$${P}_{Ave} ( {I}_{Bias} , {I}_{Modulation} ) = {P}_{0} ( {I}_{Bias} ) + Δ P ( {I}_{Modulation} )$$

$$\begin{matrix}SE = \frac{d {P}_{Ave}}{d {I}_{Drive}} \\ = \frac{d {P}_{Ave}}{d ( {I}_{Bias} + \frac{{I}_{Modulation}}{2} )} {\vert}_{{I}_{Modulation} = Constant} \\ = \frac{d {P}_{Ave}}{d {I}_{Bias}}\end{matrix}$$

$$\begin{matrix}SE = \frac{d {P}_{Ave}}{d {I}_{Bias}} \\ = \frac{d {P}_{0} ( {I}_{Bias} ) + d Δ P ( {I}_{Modulation} )}{d {I}_{Bias}} \\ = \frac{d {P}_{0} ( {I}_{Bias} )}{d {I}_{Bias}}\end{matrix}$$

The above equations illustrate that for optical driver 404 controlling the bias current (e.g., adjusting the bias current via the feedback loop of optical driver 404), a change in average power manifests as a change in the P0 level. Because Ibias determines the level of P0, a change in average power results in a change in Ibias. The change in Pave is related to the change in Ibias by slope efficiency.

In other words, slope efficiency determination module 408 may read the present value of the bias current for the present average power level (e.g., a first bias current level for a first average power level), and may then cause optical driver 404 to adjust the power from the first average power level to a second average power level. Slope efficiency determination module 408 may determine (e.g., read) the bias current level when optical source 402 is outputting at the second average power level (e.g., the second bias current level). Slope efficiency determination module 408 may determine the slope efficiency as being equal to (second average power level−first average power level)/(second bias current level−first bias current level).

In this technique, slope determination module 408 may determine the slope efficiency in the vicinity of P0. Some examples of optical source 402 may have a curved slope efficiency versus drive current characteristic near P0. The results of determining the slope efficiency near P0 may result in less accurate results as compared to if slope efficiency determination module 408 determined the slope efficiency at a different level.

Based on the above equations, the equation for Imodulation_{N+1} may be

Imodulation_{N+1}=(P1−P0)/SE_{N}=ΔP/SE_{N}=2*Pave/SE_{N}*((ER−1)/(ER+1))

As can be seen from the equation of Imodulation_{N+1}, the value of Imodulation_{N+1} is based on average power output by optical source 402, the instant slope efficiency (SE), and the desired extinction ratio (ER). Current determination module 410 may implement this equation to determine the modulation current needed to maintain the extinction ratio to within the desired range.

The above provide two example techniques for determining the slope efficiency; however, aspects of this disclosure are not so limited. In some examples, optical driver 404 may be configured to adjust the bias current to maintain the average power level at the desired level. In these examples, slope efficiency determination module 408 may determine the first modulation current level and the first bias current level that causes optical source 402 to output at the first average power level. Slope efficiency determination module 408 may then adjust the average power level from the first average power level to a second average power level. In this example, optical driver 404 may adjust the bias current from the first bias current level to the second bias current level.

Current determination module 410 may then adjust the modulation level iteratively until the bias current level returns from the second bias current level back to the first bias current level. For example, while optical driver 404 causes the bias current, at the second bias current level, to flow through optical source 402, control unit 406 may adjust the modulation current from the first modulation current level to a first temporary modulation current level. Because the change in the modulation current affects the average power output, this adjustment in the modulation current may cause optical driver 404 to adjust the bias current from the second bias current level to a first temporary bias current level. Slope efficiency determination module 408 may determine whether the first temporary bias current level is equal to the first bias current level.

If it is not, slope efficiency determination module 408 and current determination module 401 may repeat these steps until the temporary bias current level equals the first bias current level. For example, if the first temporary bias current level does not equal the first bias current level, current determination module 410 may adjust the modulation current to a second temporary modulation current level, causing optical driver 404 to flow the bias current at a second temporary bias current level. Slope efficiency determination module 408 may then determine whether the second temporary bias current level equals the first bias current level, and so forth. In this manner, control unit 406 may implement an iterative loop that modifying the modulation current from a first modulation current level to a temporary modulation current level where at the temporary modulation current level, the bias current level equals the first bias current level and the average power output by optical source 402 is equal to the second average power level.

Slope efficiency determination module 408 may then determine the instant slope efficiency as (second average power level−first average power level)/(temporary modulation current level−first modulation current level). Again, the temporary modulation current level is the result of the iterative loop that indicates the modulation current needed to cause optical source 402 to output at the second average power level with a bias current equal to the first bias current level. In other words, after the iterative loop the average power is at the second average power level, the modulation current is at the temporary modulation current level, but the bias current is at the same bias current level when the average power is at the first average power level. After slope efficiency determination module 408 determines the slope efficiency, control unit 406 may determine either the Ibias_{N+1} level or the Imodulation_{N+1} level, as described above.

Moreover, the above example techniques describe examples in which optical driver 404 is DC-coupled to optical source 402. However, in some examples, optical driver 404 may be AC-coupled, via an AC coupling capacitor, to optical source 402. In examples where optical driver 404 is AC-coupled to optical source 402, the bias current may be current needed to produce Pave from optical source 402.

With some minor modifications, the above techniques may be extended to systems in which optical driver 404 is AC-coupled to optical source 402. For example, assume that optical driver 404 is configured, via its feedback loop, to control the bias current to maintain the average output power level. The following equations illustrate the manner in which slope efficiency determination module 408 and current determination module 410 may determine the slope efficiency and the current needed to maintain the extinction ratio to within the desired range.

Pave=SE*(Ibias−Ithreshold)

dPave/dIbias=SE, which is approximately equal to ΔPave/ΔIbias

Imodulation_{N+1}=ΔP/SE

In the above example, optical driver 404 adjusted the bias current to maintain the average power in examples where optical driver 404 is AC-coupled to optical source 402. In some examples, it may not be possible for optical driver 404 to adjust the modulation current to maintain the average output power of optical source 402. For example, when optical driver 404 is AC-coupled to optical source 402, the average output power of optical source 402 is a function of bias current, and not a function of modulation current. Accordingly, changes in the modulation current do not affect the average output power of optical source 402 in examples where optical driver 404 is AC-coupled to optical source 402.

In the techniques described in this disclosure, control unit 406, via slope efficiency determination module 408 and current determination module 410, may determine the drive current (e.g., the combination of the bias current and the modulation current) needed to maintain the extinction ratio within a desirable range. To determine the needed drive current, control unit 406 determines the present slope efficiency of optical source 402. To determine the slope efficiency, control unit 406 perturbs the present average optical power output by optical source 402 and determines the drive current needed to cause optical source 402 to output at the perturbed average optical power.

In this way, control unit 406 may be configured to implement techniques for maintaining the average power output by optical source 402 and the extinction ratio, where the extinction ratio is a ratio between the power output at an optical high and the power output at an optical low (i.e., P1/P0) without needing precision measurements of high-speed (wide bandwidth) parameters. For example, in some other techniques, it may be possible determine the slope efficiency of optical source 402 without perturbing the average power output by optical source 402. In these other techniques, an optical power level meter may be coupled to optical source 402, and may measure the power level of P1 when optical source 402 outputs a digital high, and the power level of P0 when optical source 402 outputs a digital low. In these other techniques, a control unit may subtract the measured P0 value from the measured P1 value to determine a delta power level. The control unit may also subtract the a value indicative of the drive current needed to produce the P0 power level from a value indicative of the drive current needed to produce the P1 power level to determine a delta current level. The control unit may then divide the delta power level by the delta current level to determine the slope efficiency.

However, measuring the power levels of P1 and P0, while optical source 402 is outputting may be costly and difficult to implement. For example, the optical signal that optical source 402 outputs may be a high bandwidth signal (e.g., in the order of giga-bits per second). Measuring the power levels of the digital highs (i.e., P1) and the digital lows (i.e., P0) for an optical signal that is transmitted in the order of giga-bits per second imposes restrictions on the packaging of the optical components of optical source 402, which increases costs. Examples of these restrictions on the packaging include extremely short laser leads, complex grounding, and low-inductance/low-capacitance interconnections.

In the techniques described in this disclosure, control unit 406 may determine the average optical power output by optical source 402 to determine the slope efficiency, rather than the power levels of P1 and P0. Determining the average optical power output by optical source 402 may not require the above restrictions on the packaging of the optical components. For example, as described above, the output of the monitor photodiode in the housing of optical source 402 may already provide a current that is indicative of the average power output by optical source 402.

Moreover, it may be possible to utilize the monitor photodiode to measure the power levels of P1 and P0. However, because the bandwidth of the current output by the monitor photodiode is substantially less than the bandwidth of the optical signal, only when optical source 402 outputs multiple consecutive identical digits would it be possible to determine the power levels of P1 and P0. For example, optical source 402 would need to output multiple consecutive digital highs before the current output by the monitor photodiode is indicative of the power level of P1. Similarly, optical source 402 would need to output multiple consecutive digital lows before the current output by the monitor photodiode is indicative of the power level of P0.

The techniques described in this disclosure may be able to determine the slope efficiency without needing optical source 402 to output multiple consecutive identical digits. For instance, control unit 406 may rely upon the average optical power output by optical source 402. The average optical power output by optical source 402 is substantially constant due to the feedback control loop. Accordingly, control unit 406 may determine the slope efficiency of optical source 402, when optical source 402 is outputting an optical signal, even in instances where the optical signal does not include multiple consecutive identical digits.

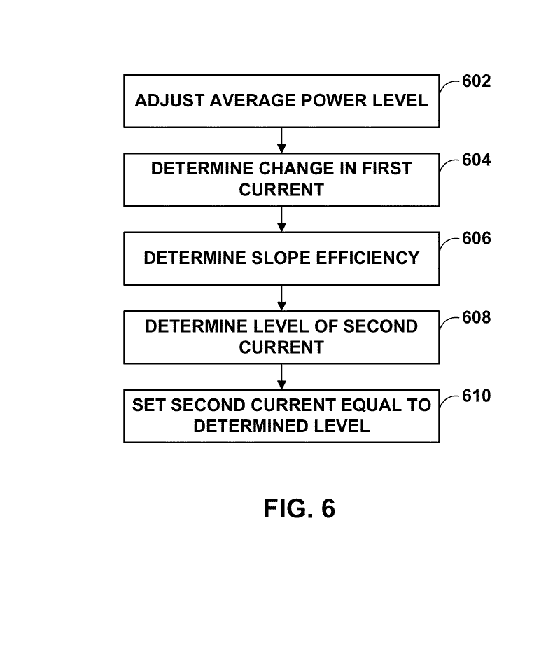

FIG. 6 is a flow diagram illustrating an example operation in accordance with one or more techniques of the present disclosure. For purposes of illustration only, the example operations are described within the context of ONU 10A as shown in FIG. 3. It should be understood that ONUs other than ONU 10A may similarly implement the techniques described in this disclosure. Moreover, OLT 12 may similarly be configured to implement the techniques described in this disclosure.

As illustrated in FIG. 6, control unit 406 may adjust the average power level of optical source 402 from a first average power level to a second average power level while optical source 402 is generating optical signals to transmit optical data (602). Control unit 406 may determine a change in a first current flowing through the laser due to the adjustment of the average power (604). While optical source 402 is generating optical signals to transmit the optical data, control unit 406 may determine the slope efficiency based at least on the adjustment of the average power and the determined change in the first current flowing through the laser (606). Control unit 406 may then determine a level of a second current based at least in part on the determined estimate of the slope efficiency (608). Control unit 406 may set the second current equal to the determined level of the second current (610).

In FIG. 6, in some examples, the first current may be the modulation current, and the second current may be the bias current. In some other examples, the first current may be the bias current, and the second current may be the modulation current.

In some examples, control unit 406 may determine the level of the second current based on an average power output by the laser, the slope efficiency, and an extinction ratio. The extinction ratio may be the desired extinction ratio. In this manner, by setting the second current to the determined level of the second current, control unit 406 may maintain the extinction ratio within a desirable range.

Moreover, control unit 406 may determine the first average power level when the laser is outputting at the first average power level, and may also determine a first level of a first current (e.g., at least one of the bias current and modulation current levels) when the laser is outputting at the first average power level. Control unit 406 may further determine a second level of the first current when the laser is outputting at the second average power level.

In these examples, control unit 406 may determine the change in the first current flowing through optical source 402 by determining a difference between the second current level and the first current level. Control unit 406 may determine the difference between the second average power level and the first average power level. Control unit 406 may divide this difference by the difference between the first and second current levels to determine the slope efficiency.

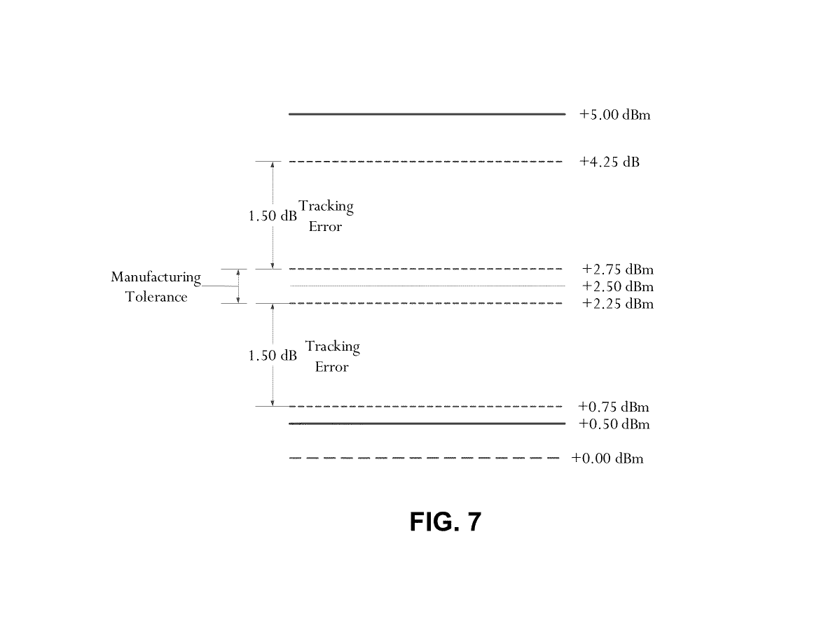

FIG. 7 is a graph illustrating the calibration tolerance and the tracking error of a laser. As illustrated, the tracking errors is ±1.5 dB for a total range of 3 dB. The calibration error (e.g., the manufacturing tolerance) is ±0.25 dB for a total range of 0.5 dB. Accordingly, 3.5 dB is lost to calibration tolerance and tracking error. FIG. 7 also illustrates that the total average power range is 5 dBm to 0.5 dBm for a range of 4.5 dBm. Therefore, the adjustment to the average power for determining the needed bias and modulation current can be ±0.5 dB, for a range of 1 dB.

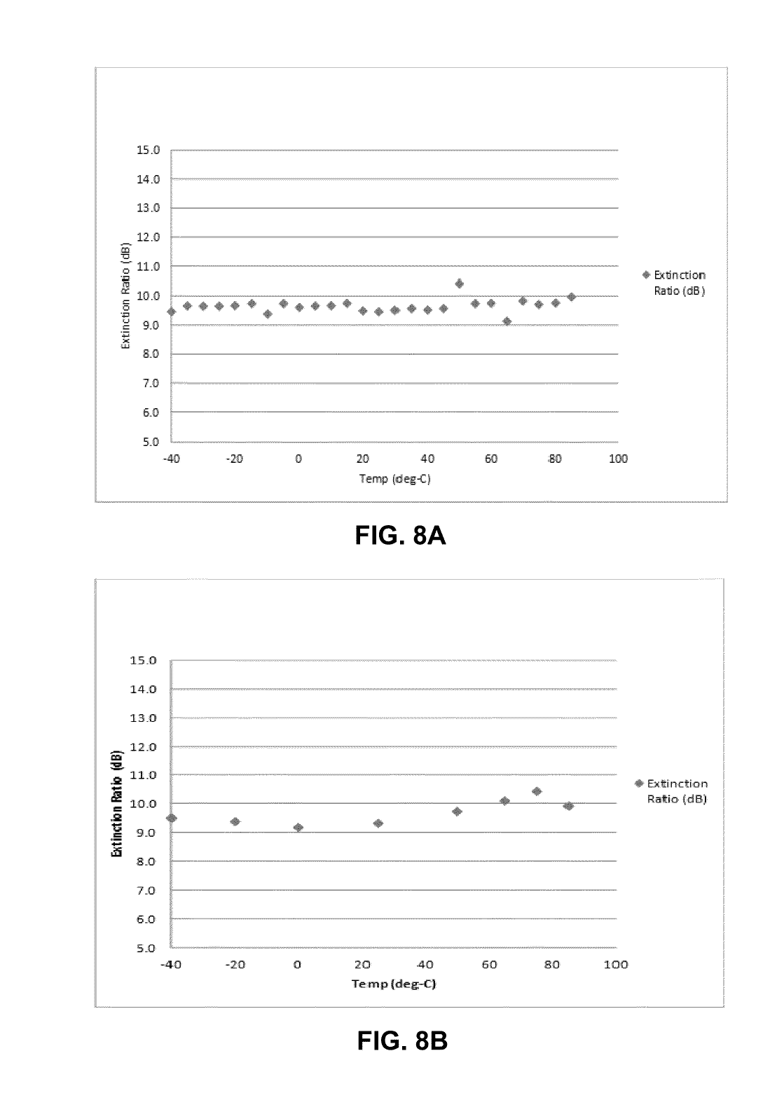

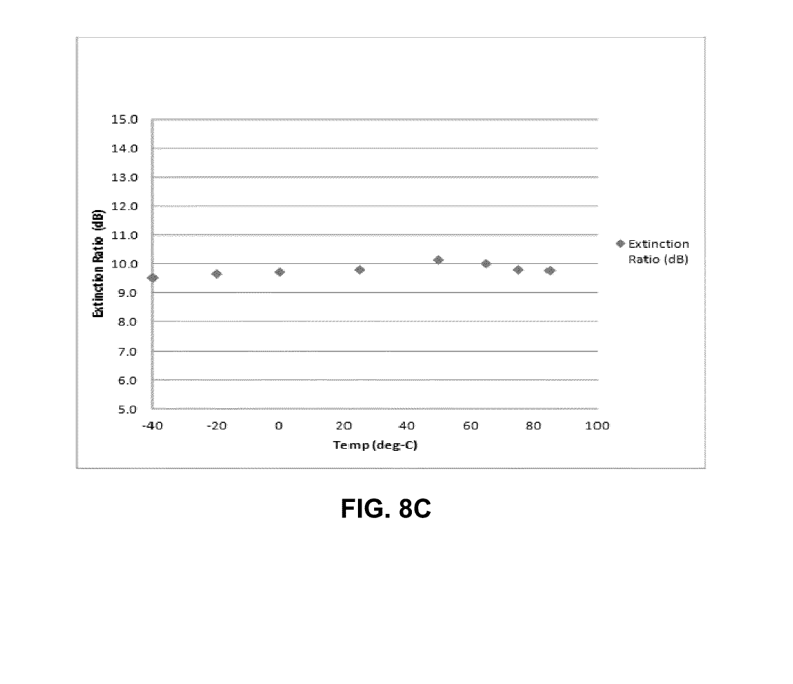

FIGS. 8A-8C are graphs illustrating the results of utilizing the techniques described in this disclosure to maintain the extinction ratio over temperature for different examples of lasers. As illustrated, the extinction ratio for all examples of optical source 402 range within 2 dB from the desired extinction ratio, and well within the GPON standard of 8.2 dB to 15 dB. Accordingly, testing shows that the techniques described in this disclosure are able to maintain the extinction ratio to within a desired range that off-the-shelf optical drivers are not able to provide.

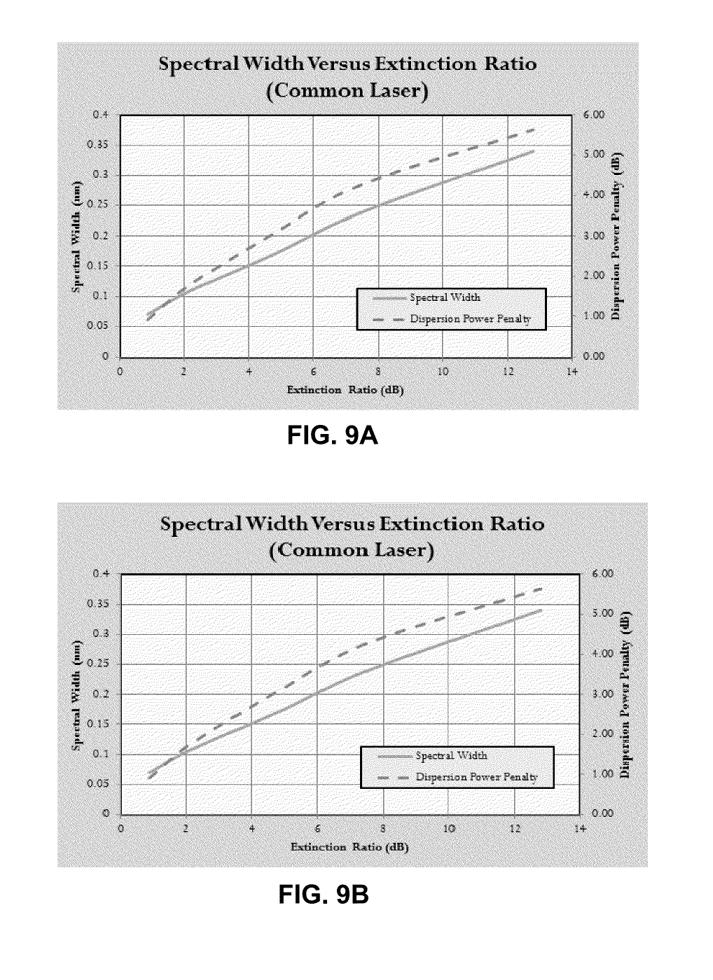

FIGS. 9A and 9B are graphs illustrating the spectral width and the dispersion power penalty of a typical laser as a function of extinction ratio. As described above, the techniques described in this disclosure control the extinction ratio to be within a desirable range over temperature and laser aging. Controlling the extinction ratio may be important to the range performance of high-speed optical systems for two reasons: (1) P1 and P0 at the receiver (e.g., the Rx at OLT 2 or Rx 12A-12N) may need to be sufficiently different in power level so that the receiver can detect the difference, and (2) the extinction ratio may be constrained to ensure that the effect of power loss due to chromatic dispersion (referred to as dispersion power penalty) stays within the levels specified. Spectral width is a parameter used in determining the dispersion power penalty. FIGS. 9A and 9B. illustrate how increasing extinction ratio results in increasing spectral width and dispersion power penalty for different examples of lasers. The techniques described in this disclosure ensure that the spectral width and dispersion power penalty are maintained within specified limits by ensuring that the extinction ratio is kept within a desirable range.

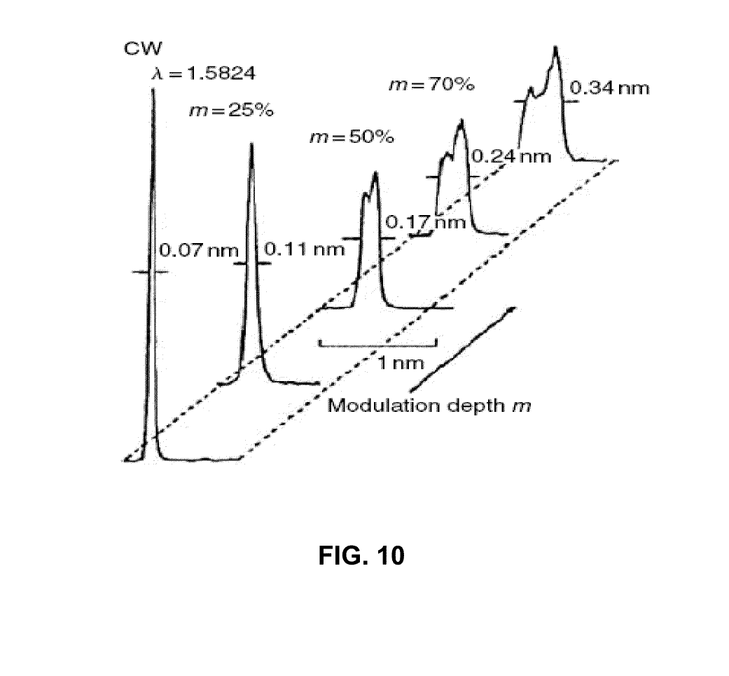

FIG. 10 is a graph illustrating the effect of modulation depth on spectral width for an example laser. As described above, some standards, such as the GPON standard may express terms in average power (Pave) and extinction ratio (ER). ER may be an important measure because large separations in P1 and P0 levels can cause the spectral width of the output power to increase. This phenomenon is referred to as chirp and may have an impact on the dispersion performance of the optical system such as PON 100. FIG. 10 illustrates how the spectral width varies with modulation depth.

Modulation depth may be related to the extinction ratio. For example, modulation depth (m) equals (P1−P0)/(P1+P0), and ER equals P1/P0. Therefore, modulation depth (m) equals (ER−1)/(ER+1). For example, ER equal to 8.2 dB is equivalent to a modulation depth of 70.7%, and an extinction ratio of 13 dB is equivalent to a modulation depth of 90.5%.

The techniques described in this disclosure may be implemented in hardware or any combination of hardware and software (including firmware). Any features described as units, modules, or components may be implemented together in an integrated logic device or separately as discrete but interoperable logic devices. If implemented in hardware, the techniques may be realized in a processor, a circuit, a collection of logic elements, or any other apparatus that performs the techniques described herein. If implemented in software, the techniques may be realized at least in part by a non-transitory computer-readable storage medium comprising instructions that, when executed in a processor, cause the processor to perform one or more of the methods described above. The non-transitory computer-readable medium may form part of a computer program product, which may include packaging materials. The non-transitory computer-readable medium may comprise random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates code in the form of instructions or data structures and that can be accessed, read, and/or executed by a computer.

The code may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein, may refer to any of the foregoing structures or any other structure suitable for implementation of the techniques described herein. Likewise, the term “control unit,” as used herein, may refer to any of the foregoing structures or any other structure suitable for implementation of the techniques described herein. In addition, in some aspects, the functionality described herein may be provided within dedicated software and hardware units configured to perform the techniques of this disclosure. Depiction of different features as units is intended to highlight different functional aspects of the devices illustrated and does not necessarily imply that such units must be realized by separate hardware or software components. Rather, functionality associated with one or more units may be integrated within common or separate hardware or software components.

Various embodiments of the invention have been described. These and other embodiments are within the scope of the following claims.

What is claimed is:

1. A method comprising:
adjusting an average power of a laser from a first average power level to a second average power level while the laser is generating optical signals to transmit optical data;
determining a change in a first current flowing through the laser due to the adjustment of the average power;
determining a slope efficiency of the laser while the laser is transmitting the optical signals based at least on the adjustment of the average power and the determined change in the first current flowing through the laser;
determining a level of a second current based at least in part on the determined estimate of the slope efficiency; and
setting the second current equal to the determined level of the second current.

2. The method of claim 1, wherein the first current is a modulation current of the laser, and the second current is a bias current of the laser.

3. The method of claim 1, wherein the first current is a bias current of the laser, and the second current is a modulation current of the laser.

4. The method of claim 1, wherein determining the level of the second current comprises determining the level of the second current based on the first average power level, the slope efficiency, and an extinction ratio.

5. The method of claim 4, wherein setting the second current comprises setting the second current equal to the determined level of the second current to maintain the extinction ratio within a desirable range.

6. The method of claim 1, further comprising:
determining the first average power level when the laser is outputting at the first average power level;
determining a first level of the first current when the laser is outputting at the first average power level; and
determining a second level of the first current when the laser is outputting at the second average power level,
wherein determining the change in the first current comprises determining a difference between the second current level and the first current level, and
wherein determining the slope efficiency comprises determining a difference between the second average power level and the first average power level and dividing a result of the difference with the determined change in the first current.

7. The method of claim 1, further comprising:
adjusting the average power of the laser back from the second average power level to the first average power level while the laser is generating optical signals to transmit optical data.

8. A device comprising:
a laser; and
a control unit, the control unit is configured to:
adjust an average power of the laser from a first average power level to a second average power level while the laser is generating optical signals to transmit optical data;
determine a change in a first current flowing through the laser due to the adjustment of the average power;
determine a slope efficiency of the laser while the laser is transmitting the optical signals based at least on the adjustment of the average power and the determined change in the first current flowing through the laser;
determine a level of a second current based at least in part on the determined estimate of the slope efficiency; and
set the second current equal to the determined level of the second current.

9. The device of claim 8, wherein the first current is a modulation current of the laser, and the second current is a bias current of the laser.

10. The device of claim 8, wherein the first current is a bias current of the laser, and the second current is a modulation current of the laser.

11. The device of claim 8, wherein the control unit is configured to determine the level of the second current based on the first average power level, the slope efficiency, and an extinction ratio.

12. The device of claim 11, wherein the control unit is configured to set the second current equal to the determined level of the second current to maintain the extinction ratio within a desirable range.

13. The device of claim 8, wherein the control unit is configured to:
determine the first average power level when the laser is outputting at the first average power level;
determine a first level of the first current when the laser is outputting at the first average power level; and
determine a second level of the first current when the laser is outputting at the second average power level,
wherein the control unit is configured to determine a difference between the second current level and first current level to the determine the change in the first current, and
wherein the control unit is configured to determine a difference between the second average power level and the first average power level and divide a result of the difference with the determined change in the first current to determine the slope efficiency.

14. The device of claim 8, wherein the control unit is configured to adjust the average power of the laser back from the second average power level to the first average power level while the laser is generating optical signals to transmit the optical data.

15. The device of claim 8, wherein the device comprises an optical network unit.

16. The device of claim 8, wherein the device comprises an optical line terminal.

17. A control unit of a device, the control unit configured to:
adjust an average power of a laser from a first average power level to a second average power level while the laser is generating optical signals to transmit optical data;
determine a change in a first current flowing through the laser due to the adjustment of the average power;
determine a slope efficiency of the laser while the laser is transmitting the optical signals based at least on the adjustment of the average power and the determined change in the first current flowing through the laser;
determine a level of a second current based at least in part on the determined estimate of the slope efficiency; and
set the second current equal to the determined level of the second current.

18. The control unit of claim 17, wherein the control unit is configured to:
determine the first average power level when the laser is outputting at the first average power level;
determine a first level of the first current when the laser is outputting at the first average power level; and
determine a second level of the first current when the laser is outputting at the second average power level,
wherein the control unit is configured to determine a difference between the second current level and first current level to the determine the change in the first current, and
wherein the control unit is configured to determine a difference between the second average power level and the first average power level and divide a result of the difference with the determined change in the first current to determine the slope efficiency.

19. A computer-readable storage medium having instructions stored thereon that when executed cause a control unit of a device to:
adjust an average power of a laser from a first average power level to a second average power level while the laser is generating optical signals to transmit optical data;
determine a change in a first current flowing through the laser due to the adjustment of the average power;
determine a slope efficiency of the laser while the laser is transmitting the optical signals based at least on the adjustment of the average power and the determined change in the first current flowing through the laser;
determine a level of a second current based at least in part on the determined estimate of the slope efficiency; and
set the second current equal to the determined level of the second current.

20. The computer-readable storage medium of claim 19, wherein the first current is a modulation current of the laser, and the second current is a bias current of the laser.

21. The computer-readable storage medium of claim 19, wherein the first current is a bias current of the laser, and the second current is a modulation current of the laser.

22. The computer-readable storage medium of claim 19, wherein the instructions that cause the control unit to determine the level of the second current comprise instructions that cause the control unit to determine the level of the second current based on the first average power level, the slope efficiency, and an extinction ratio.

23. The computer-readable storage medium of claim 22, wherein the instructions that cause the control unit to set the second current comprise instructions that cause the control unit to set the second current equal to the determined level of the second current to maintain the extinction ratio within a desirable range.

24. The computer-readable storage medium of claim 19, further comprising instructions that cause the control unit to:
determine the first average power level when the laser is outputting at the first average power level;
determine a first level of the first current when the laser is outputting at the first average power level; and
determine a second level of the first current when the laser is outputting at the second average power level,
wherein the instructions that cause the control unit to determine the change in the first current comprise instructions that cause the control unit to determine a difference between the second current level and the first current level, and
wherein the instructions that cause the control unit to determine the slope efficiency comprise instructions that cause the control unit to determine a difference between the second average power level and the first average power level and divide a result of the difference with the determined change in the first current.

25. The computer-readable storage medium of claim 19, further comprising instructions that cause the control unit to:
adjust the average power of the laser back from the second average power level to the first average power level while the laser is generating optical signals to transmit optical data.

26. A device comprising:
means for adjusting an average power of a laser from a first average power level to a second average power level while the laser is generating optical signals to transmit optical data;
means for determining a change in a first current flowing through the laser due to the adjustment of the average power;
means for determining a slope efficiency of the laser while the laser is transmitting the optical signals based at least on the adjustment of the average power and the determined change in the first current flowing through the laser;
means for determining a level of a second current based at least in part on the determined estimate of the slope efficiency; and
means for setting the second current equal to the determined level of the second current.

27. The device of claim 26, wherein the first current is a modulation current of the laser, and the second current is a bias current of the laser.

28. The device of claim 26, wherein the first current is a bias current of the laser, and the second current is a modulation current of the laser.

29. The device of claim 26, wherein the means for determining the level of the second current comprises means for determining the level of the second current based on the first average power level, the slope efficiency, and an extinction ratio.

30. The device of claim 29, wherein the means for setting the second current comprises means for setting the second current equal to the determined level of the second current to maintain the extinction ratio within a desirable range.

31. The device of claim 26, further comprising:
means for determining the first average power level when the laser is outputting at the first average power level;
means for determining a first level of the first current when the laser is outputting at the first average power level; and
means for determining a second level of the first current when the laser is outputting at the second average power level,
wherein the means for determining the change in the first current comprises means for determining a difference between the second current level and the first current level, and
wherein the means for determining the slope efficiency comprises means for determining a difference between the second average power level and the first average power level and means for dividing a result of the difference with the determined change in the first current.

32. The device of claim 26, further comprising:
means for adjusting the average power of the laser back from the second average power level to the first average power level while the laser is generating optical signals to transmit optical data.
